(19) United States
(12) Patent Application Publication
(10) Pub. No.: US 2017/0210263 A1
(43) Pub. Date: Jul. 27, 2017

(54) INTEGRATED INDEPENDENT THIGH SUPPORTS

(71) Applicant: FORD GLOBAL TECHNOLOGIES, LLC, Dearborn, MI (US)

(72) Inventors: JOHNATHAN ANDREW LINE, Northville, MI (US); Marcos Silva Kondrad, Macomb Township, MI (US); David Frederick Lyons, New Haven, MI (US); Daniel Ferretti, Commerce Township, MI (US); Kevin Wayne Preuss, Berkley, MI (US)

(73) Assignee: FORD GLOBAL TECHNOLOGIES, LLC, Dearborn, MI (US)

(21) Appl. No.: 15/294,879

(22) Filed: Oct. 17, 2016

Related U.S. Application Data
(63) Continuation-in-part of application No. 15/005,077, filed on Jan. 25, 2016.

(51) Int. Cl. B60N 2/62; B60N 2/68; B60N 2/54; B60N 2/70

(52) U.S. Cl. CPC B60N 2/62; B60N 2/70; B60N 2/686; B60N 2/544

(57) ABSTRACT

A vehicle seating assembly for a motor vehicle has a lower seat comprising a cushion frame assembly connected to a vehicle floor, the cushion frame assembly comprising a cushion pan that forms a forward portion of the cushion frame assembly. A pair of independent thigh supports is symmetrically disposed along either side of a longitudinal centerline of the vehicle seating assembly and is operably coupled to the cushion pan, wherein each of the independent thigh supports comprises a resilient member having a predetermined hysteresis support-curve to provide independent and resilient support for each thigh of an occupant's legs. A cushion foam assembly is disposed above and operably coupled to the cushion frame, a forward portion of the cushion foam assembly being supported by the pair of independent thigh supports.

### CROSS-REFERENCE TO RELATED APPLICATIONS AND CLAIM TO PRIORITY

This application is a continuation-in-part of and claims priority under 35 U.S.C. §120 to commonly owned, co-pending, related U.S. patent application Ser. No. 15/005,077, filed Jan. 25, 2016, entitled INTEGRATED INDEPENDENT THIGH SUPPORTS, the entire disclosure of which is incorporated herein by reference.

### FIELD OF THE INVENTION

The present invention generally relates to a vehicle seating assembly for a vehicle, and more particularly to a vehicle seating assembly having independent thigh supports.

### BACKGROUND OF THE INVENTION

Motor vehicle customers value and appreciate features that enhance their driving experience. In particular, consumers value and appreciate features in a vehicle seating assembly that provide additional comfort features to reduce driving stress and fatigue. Additionally, consumers are looking for such features at reasonable cost, from value oriented vehicle seating assembly applications to high performance seating vehicle seating assembly applications. Hence, a vehicle seating assembly which assists in providing additional comfort features to reduce driving stress and fatigue would be advantageous.

### SUMMARY OF THE INVENTION

One aspect of the present disclosure includes a vehicle seating assembly for a vehicle that assists in providing additional comfort features to reduce driving stress and fatigue.

Another aspect of the present disclosure includes a vehicle seating assembly for a motor vehicle having a lower seat comprising a cushion frame assembly connected to a vehicle floor, the cushion frame assembly comprising a cushion pan that forms a forward portion of the cushion frame assembly. A pair of independent thigh supports is symmetrically disposed along either side of a longitudinal centerline of the vehicle seating assembly and is operably coupled to the cushion pan, wherein each of the independent thigh supports comprises a resilient member having a predetermined hysteresis support-curve to provide independent and resilient support for each thigh of an occupant's legs. A cushion foam assembly is disposed above and operably coupled to the cushion frame, a forward portion of the cushion foam assembly being supported by the pair of independent thigh supports.

Yet another aspect of the present disclosure includes a seat assembly comprising a cushion frame assembly comprising a cushion pan, a trim and foam layer, and a pair of laterally displaced independent thigh supports disposed between the cushion pan and the trim and foam layer. The pair of independent thigh supports is supported by the cushion pan and resiliently supports the trim and foam layer above the cushion pan.

A further aspect of the present disclosure includes a vehicle seating assembly for a motor vehicle having a lower seat and a seatback extending upwardly from the lower seat. The lower seat comprises a cushion frame assembly operably connected to a vehicle floor, and a forward portion of the cushion frame assembly comprises a cushion pan. A pair of independent thigh supports having a predetermined hysteresis support-curve is operably coupled with the cushion pan. The pair of independent thigh supports is symmetrically disposed along either side of a longitudinal centerline of the vehicle seating assembly and a gap separates the pair of independent thigh supports along the longitudinal centerline of the vehicle seating assembly. A cushion foam assembly is disposed above and is attached to the cushion frame assembly. A forward portion of the cushion foam assembly is supported by the pair of independent thigh supports.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1A is a perspective view of a first embodiment of the vehicle seating assembly in accordance with the present disclosure installed in the motor vehicle;

FIG. 1B is a perspective view of a second embodiment of the vehicle seating assembly in accordance with the present disclosure installed in the motor vehicle;

FIG. 2A is a perspective view of the first embodiment of the vehicle seating assembly in accordance with the present disclosure;

FIG. 2B is a perspective view of the second embodiment of the vehicle seating assembly in accordance with the present disclosure;

FIG. 3 is a perspective view of the lower seat of the first embodiment of the vehicle seating assembly in accordance with the present disclosure;

FIG. 4 is an exploded perspective view of the lower seat of the first embodiment of the vehicle seating assembly in accordance with the present disclosure, disclosing a first embodiment of independent thigh supports;

FIG. 5 is a front perspective view of the cushion frame assembly in accordance with the present disclosure, disclosing the first embodiment of the independent thigh supports;

FIG. 6 is a rear perspective view of the cushion frame assembly in accordance with the present disclosure, disclosing the first embodiment of the independent thigh supports;

FIG. 7A is a front perspective view of the seatback with the upper movable seatback hood module in the lowermost position in accordance with the present disclosure;

FIG. 7B is a front perspective view of the seatback with the upper movable seatback hood module in the uppermost position in accordance with the present disclosure;

FIG. 8 is a front perspective view of the upper movable seatback hood module in accordance with the present disclosure;

FIG. 9 is a front perspective view of the headrest in accordance with the present disclosure;

FIG. 9A is an exploded front perspective view of the headrest in accordance with the present disclosure;

FIG. 9B is an exploded front perspective view of the headrest, headrest dovetail, headrest cup, dovetail receiver, and rear upper slide bracket in accordance with the present disclosure;

FIG. 10 is a front perspective view of the headrest cup in accordance with the present disclosure;

FIG. 11 is a rear exploded perspective view of the headrest dovetail, roller bearings, and dovetail receiver in accordance with the present disclosure;

FIG. 12 is a front perspective view of the U-shaped member of the headrest in accordance with the present disclosure;

FIG. 13 is a front perspective view of the upper movable seatback hood module in accordance with the present disclosure;

FIG. 14 is a front perspective view of the upper movable seatback hood module and the U-shaped member installed in accordance with the present disclosure;

FIG. 15 is a front perspective view of the upper movable seatback hood module with the headrest removed in accordance with the present disclosure;

FIG. 16 is a cross-sectional view of the upper portion of the seatback in accordance with the present disclosure;

FIG. 17 is an exploded front perspective view of the upper movable seatback hood module in accordance with the present disclosure;

FIG. 18 is a front perspective view of the rear upper slide bracket of the seatback in accordance with the present disclosure;

FIG. 19 is a rear view of the rear upper slide bracket of the seatback in accordance with the present disclosure;

FIG. 20 is a front perspective view of the seatback frame assembly and the back frame bracket of the seatback in accordance with the present disclosure;

FIG. 21 is a front perspective view of the rail guides and rails of the seatback in accordance with the present disclosure;

FIG. 22 is a front perspective view of the back frame bracket of the seatback in accordance with the present disclosure;

FIG. 23 is a rear perspective view of the back frame reinforcement bracket of the seatback in accordance with the present invention;

FIG. 24 is a rear perspective view of the motor nut of the seatback in accordance with the present invention;

FIG. 25 is a front perspective view of the electric motor drive unit of the seatback in accordance with the present invention;

FIG. 26 is a side perspective view of the trim panel of the vehicle seating assembly in accordance with the present invention;

FIG. 27 is a front perspective schematic view of certain components of the cushion frame assembly in accordance with the present disclosure, disclosing a second embodiment of the independent thigh supports;

FIG. 28 is a side cross-sectional schematic view of certain components of the cushion frame assembly in accordance with the present disclosure taken along the plane 27-27 shown in FIG. 27, disclosing the second embodiment of the independent thigh supports in the unloaded condition;

FIG. 29 is a side cross-sectional schematic view of certain components of the cushion frame assembly in accordance with the present disclosure taken along the plane 27-27 shown in FIG. 27, disclosing the second embodiment of the independent thigh supports in the loaded condition;

FIG. 30 is a front perspective schematic view of certain components of the cushion frame assembly in accordance with the present disclosure, disclosing a third embodiment of the independent thigh supports;

FIG. 31 is a side cross-sectional schematic view of certain components of the cushion frame assembly in accordance with the present disclosure taken along the plane 30-30 shown in FIG. 30, disclosing the third embodiment of the independent thigh supports in the unloaded condition;

FIG. 32 is a side cross-sectional schematic view of certain components the cushion frame assembly in accordance with the present disclosure taken along the plane 30-30 shown in FIG. 30, disclosing the third embodiment of the independent thigh supports in the loaded condition;

FIG. 33 is a first predetermined hysteresis support-curve for a preferred pair of lattice-shaped support inserts in accordance with the present disclosure;

FIG. 34 is a second predetermined hysteresis support-curve for the preferred pair of lattice-shaped support inserts in accordance with the present disclosure; and

FIG. 35 is a third predetermined hysteresis support-curve for a preferred pair of lattice-shaped support inserts in accordance with the present disclosure.

### DETAILED DESCRIPTION OF THE EMBODIMENTS

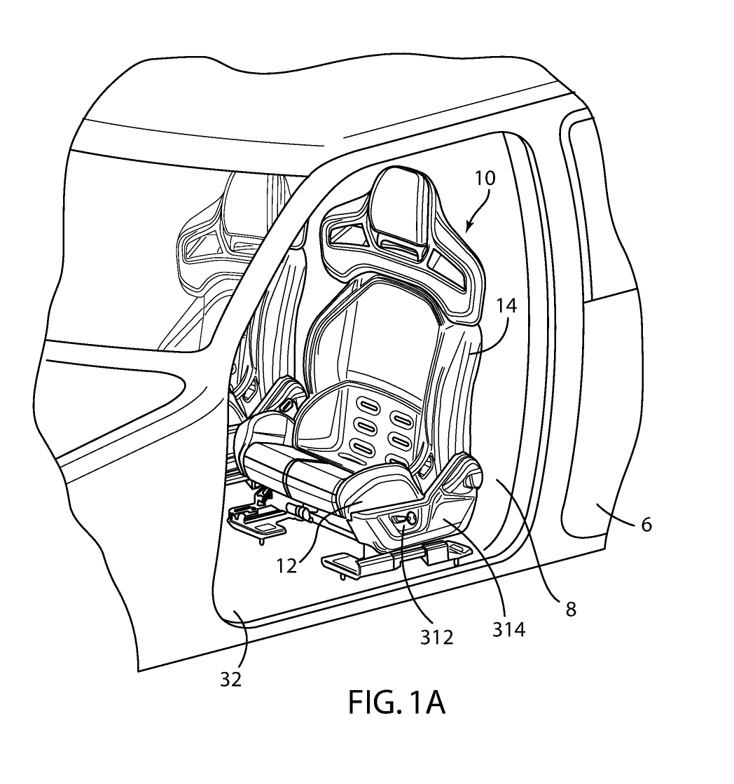

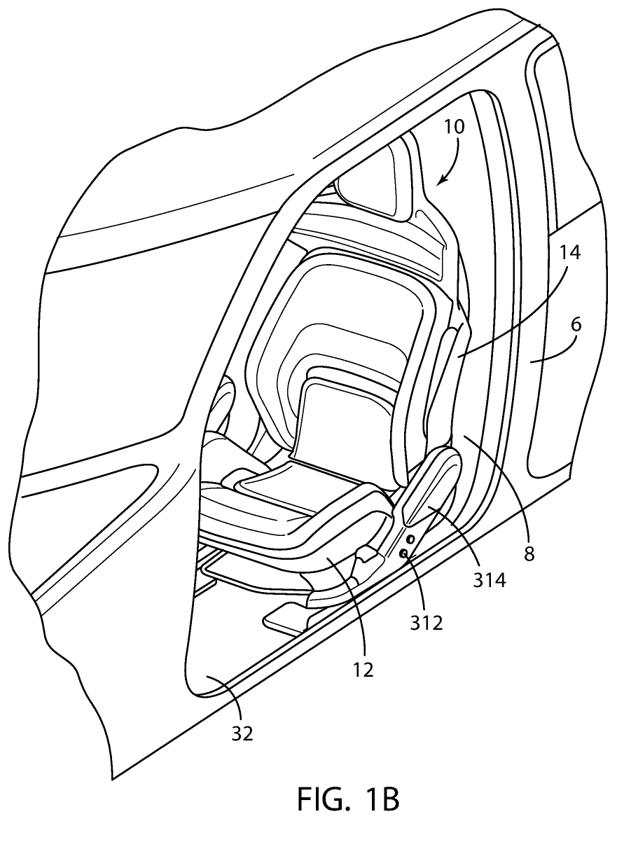

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

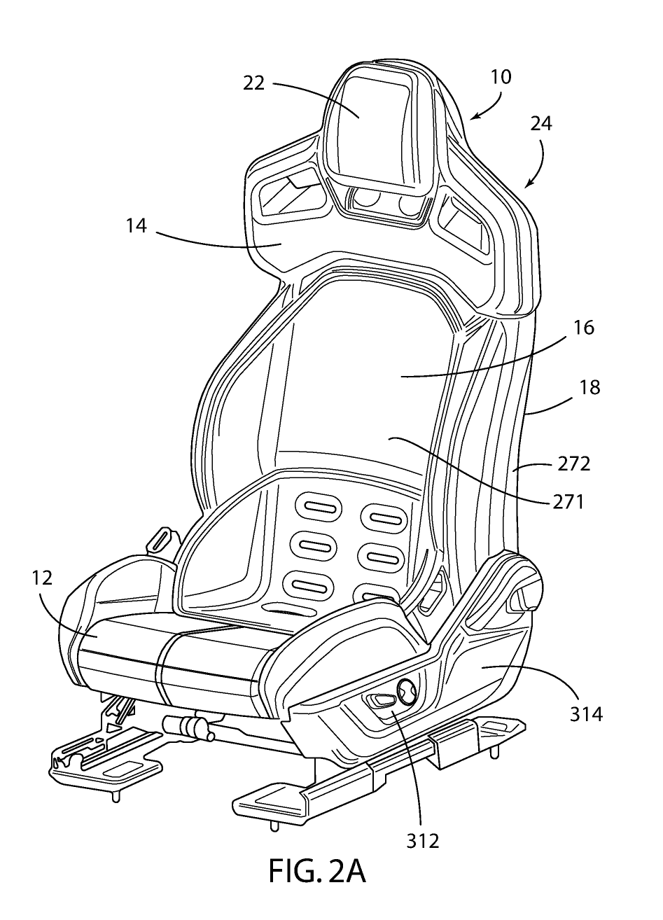

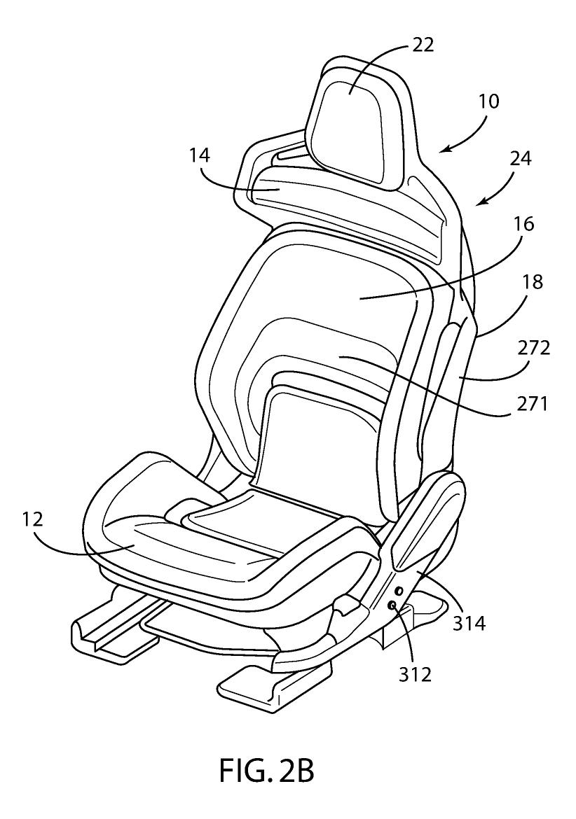

Referring to FIGS. 1A and 2A, a vehicle seating assembly 10 is illustrated inside the vehicle cabin 8 of a vehicle 6. The vehicle seating assembly 10 may be a seat for a driver, a seat for a passenger, a rear bucket seat, a rear row of seats, as shown, or any other vehicle seat. The vehicle seating assembly 10 includes a lower seat 12 and a seatback 14 pivotably attached to the lower seat 12. The seatback 14 of the vehicle seating assembly 10 includes a forward facing surface 16 and a rearward facing surface 18, each of which may be covered with a protective and/or decorative material 20. Leather and/or vinyl are often and preferably employed. The vehicle seating assembly 10 also includes a headrest 22 operably coupled to an upper portion 24 of the seatback 14 of the vehicle seating assembly 10. The vehicle seating assembly 10 also typically includes a vehicle seat base 26 configured to provide structural support to the vehicle seating assembly 10. The vehicle seat base 26 is preferably supported on seat mounting rail assemblies 28, as is known in the art. The seat mounting rail assembly 28 is configured to allow the vehicle seating assembly 10 to be adjusted in forward and rearward directions relative to the longitudinal axis of the vehicle 6.

It is understood that the vehicle seating assembly 10 may be positioned in various locations throughout the vehicle other than the illustrated position, such as a passenger side location, a mid-row location, and a rear seat location. The vehicle seating assembly 10 is thereby slidably coupled with a floor 32. It is also conceivable that the vehicle seating assembly 10 may not include the seat mounting rail assembly 28 and alternatively may be fixedly coupled with the floor 32 of the vehicle.

It is also understood that the seating assembly 10 may be configured in different forms and styles. For example, as shown in FIGS. 1B and 2B, the lower lumber support has been modified to provide a more inclined lumber support. Also, the lower seat has been modified to extend further forward to provide greater support of the occupant's thighs.

Lower seat 12 includes a cushion frame assembly 30, which in turn includes a cushion frame 34 to which a seat belt buckle 36 is attached. A suspension system 38 is disposed within a rear portion 40 of the cushion frame assembly 30 and beneath and juxtaposed with a cushion foam assembly 42 comprising trim and foam layers disposed above for support of the occupant. The cushion foam assembly 42 is preferably operably coupled with the cushion frame assembly 30. The suspension system 38 is preferably formed from tunable springs 44 which support a central panel 46. Preferably, at least one variable tension spring 48 is mounted to the cushion frame assembly 30. The suspension system 38 may also include a motor 50, a gear 52, and a spring attachment member 54. A fixedly mounted connecting rod 56 extends between lateral sides 58, 60 of the cushion frame 34 and a sleeve 62 rotatably encircles the connecting rod 56. The motor 50 and gear 52 are operably coupled to the sleeve 62 and the spring attachment member 54 is rigidly mounted on the sleeve 62.

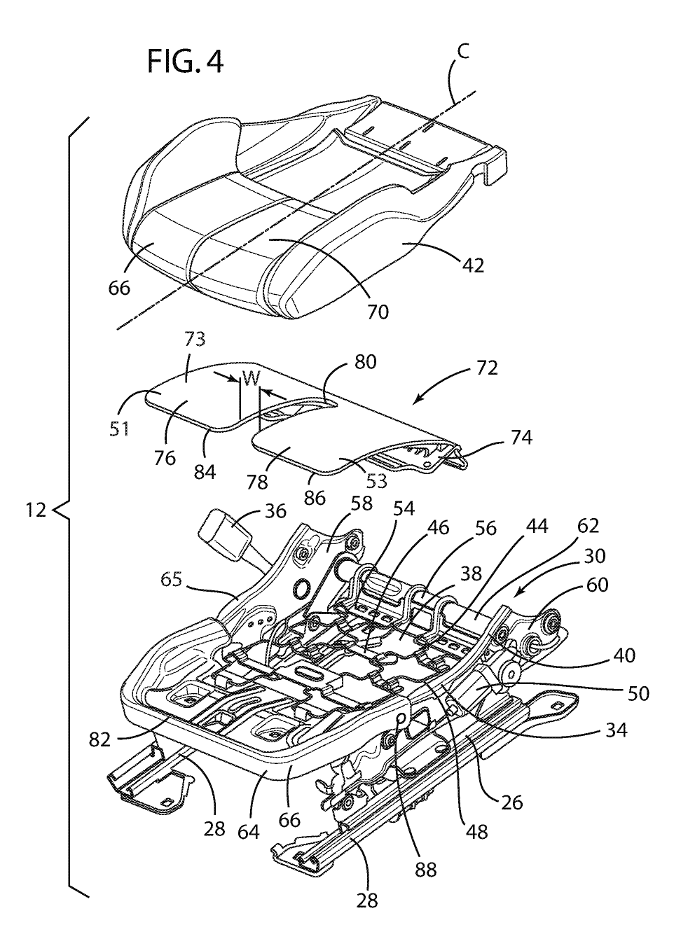

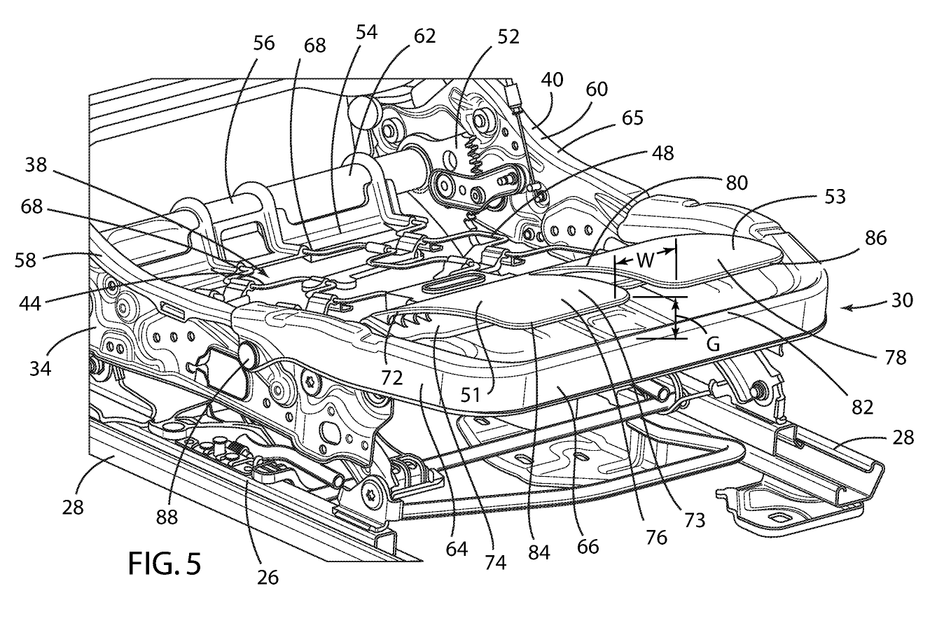

As shown in FIGS. 4 and 5, the variable tension springs 48 are mounted in tension between the spring attachment member 54 and a cushion pan 64 pivotably mounted to and forming a forward portion 66 of the cushion frame 34. When activated, the motor 50 and gear 52 are adapted to rotate the sleeve 62 and spring attachment member 54. In the illustrated example, rotating the sleeve 62 and spring attachment member 54 rearward raises a rear portion 68 of the variable tension springs 48 and increases the tension applied to the variable tension springs 48. Raising the rear portion 68 of the variable tension springs 48 raises the height of the seating surface 70. Additionally, as is understood by one of ordinary skill in the art, increasing the tension on the variable tension springs 48 decreases the flex or extension thereof, which means the variable tension springs 48 and cushion foam assembly 42 will move downward a smaller distance when placed under load, such as when an occupant sits on the vehicle seating assembly 10. Conversely, rotating the sleeve 62 and spring attachment member 54 forward lowers the rear portion 68 of the variable tension springs 48 and decreases the tension applied to the variable tension springs 48. This increases the flex or extension of the variable tension springs 48, which means the variable tension springs 48 and cushion foam assembly 42 will move downward a greater distance when an occupant is seated in vehicle seating assembly 10. Further, lowering the rear portion 68 of the variable tension springs 48 lowers the height of the seating surface 70.

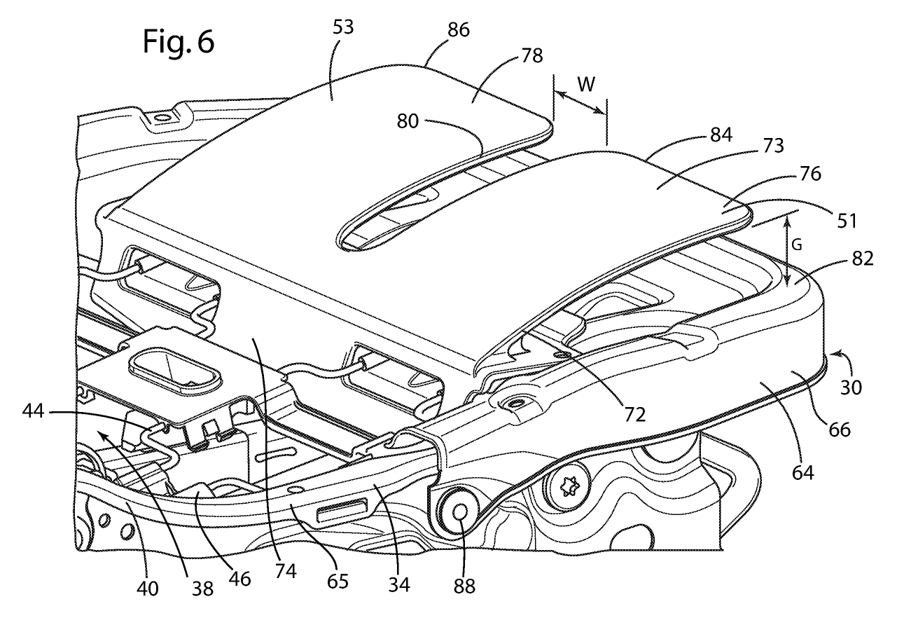

A further innovation is as shown in FIGS. 4-6 and 27-32, which shows a vehicle seating assembly 10 that includes a pair of independent thigh supports 51, 53 symmetrically disposed along either side of a longitudinal centerline C of the vehicle seating assembly 10 and operably coupled to the cushion pan 64. Each of the pair of resilient independent thigh supports 51, 53 has a predetermined hysteresis support-curve to provide independent and resilient support for each thigh of an occupant's legs. A gap G separates the pair of independent thigh supports 51, 53 along the longitudinal centerline C of the vehicle seating assembly. The cushion foam assembly 42 is disposed above and is operably coupled to the cushion frame 34, where a forward portion 45 of the cushion foam assembly 42 is resiliently supported by the pair of independent thigh supports 51, 53.

In a first embodiment of the independent thigh supports 51, 53 shown in FIGS. 4, 5, and 6, the pair of independent thigh supports 51, 53 comprise a cushion leg jounce bracket 72 attached to a rear portion 65 of the cushion pan 64, preferably at a point about longitudinally midway on the cushion frame 34. The cushion leg jounce bracket 72 includes a base 74 attached to the cushion pan 64 with two curved jounce paddles 76, 78. Preferably, the resilient curvilinear cantilevered jounce paddles 76, 78 extend forwardly from a base and act much like a diving board or cantilevered beam to support the back of the thighs. The pair of jounce paddles 76, 78 are thus disposed between and operably coupled with each of an underside of the cushion foam assembly 42 and the cushion pan 64.

A cushion leg jounce bracket 72 forms the pair of jounce paddles 76, 78 symmetrically disposed along either side of a longitudinal centerline C of the vehicle seating assembly, with a notch 80 separating each of the jounce paddles 76, 78 at the base 74 along the longitudinal centerline C of the vehicle seating assembly. As a result, a gap W separates each of the jounce paddles 76, 78 along the longitudinal centerline C of the vehicle seating assembly, as shown. Preferably, each of the jounce paddles 76, 78 is about 150 mm wide transverse to the longitudinal centerline C of the vehicle so as to provide adequate support to the back of each of an occupant's thighs.

Each of the jounce paddles 76, 78 extends upwardly and forwardly to form a vertical gap G between a distal end 84, 86 of each jounce paddle 76, 78 and a forward edge 82 of the cushion pan 64 and is thereby preferably disposed to independently support one of the occupant's thighs. Each of the jounce paddles 76, 78 may be resiliently urged downwardly by the weight of the occupant's thigh without contacting the forward edge 82 of the cushion pan 64 and thereby provide resilient support. However, is it conceivable that the cushion leg jounce bracket 72 may be arranged having a pair of jounce paddles 76, 78 that may be selectively coupled and uncoupled to act independently under a respective thigh of the occupant.

The cushion leg jounce bracket 72 is preferably formed as a single molded component, but may be formed from two symmetrical pieces arranged on either side of the longitudinal centerline C of the vehicle seating assembly 10, each comprising one of the jounce paddles 76, 78. Preferably, the cushion leg jounce bracket 72 is formed from glass-filled injection molded nylon having a thickness of about between 2.5 and 3.5 mm. However, it should be noted that the cushion leg jounce bracket 72 may be effectively tunable to specific performance criteria by appropriate selection of the material from which the cushion leg jounce bracket 72 is fabricated, the thickness of the cushion leg jounce bracket 72, the addition of ribs (not shown) on the bottom of the paddles on the cushion leg jounce bracket 72, and the addition of a split line along the cushion leg jounce bracket 72 proximate the base 74 of the notch 80 separating the pair of jounce paddles 76, 78.

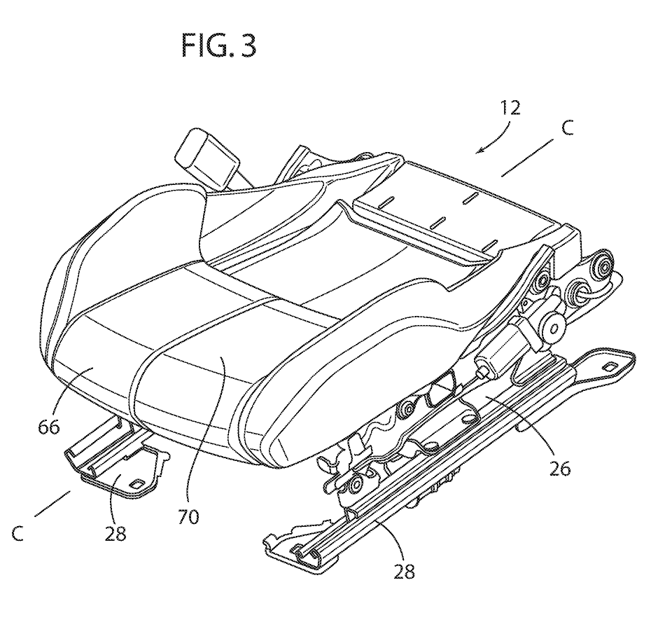

The cushion foam assembly 42 is disposed above and is attached to the cushion frame 34, as shown in FIG. 3, and is supported at a forward portion 73 by the cushion leg jounce bracket 72. Preferably, the underside 43 of the cushion foam assembly 42 is provided with a durable surface material that is particularly wear resistant, given that those areas are where relative movement between the jounce paddles 76, 78 of the cushion leg jounce bracket 72 and the underside 43 of the cushion foam assembly 42 will occur and tend to wear on the underside 43 of the cushion foam assembly 42.

Preferably, the cushion pan 64 is pivotably, and thereby adjustably, mounted to the cushion frame 34 by a pair of pivots 88 located on either side of the cushion frame assembly 30. The cushion pan 64 so mounted may be manually and pivotally adjusted by use of a knob or lever (not shown), as is well known in the seating arts, or a remotely pivotally adjusted by use of a motorized gear assembly (not shown), as is also well known in the seating arts.

The cushion leg jounce bracket 72 disclosed herein thus provides a pair of resilient independent thigh supports 51, 53 that assembles directly to the cushion pan 64. The cushion leg jounce bracket 72 provides passive support and acts independently under the load of each leg, and thereby reduces leg muscle fatigue and provides support for important vehicle functions, especially such as acceleration and braking with the right leg and manual gear shift or relaxation on the left leg.

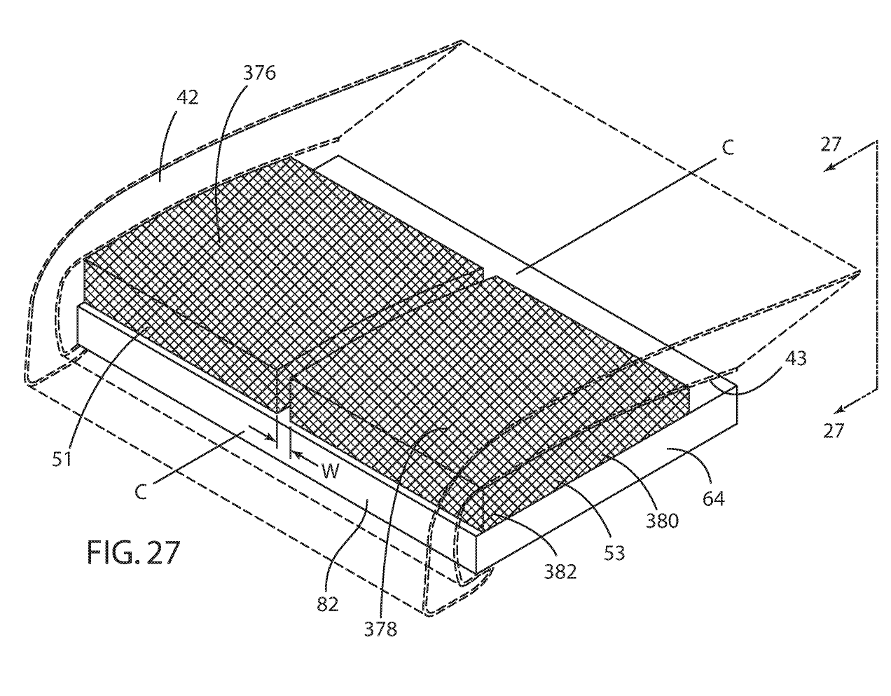

A second embodiment of the independent thigh supports 51, 53 is shown in FIGS. 27, 28, and 29. In this embodiment, the pair of independent thigh supports 51, 53 comprises a pair of lattice-shaped support inserts 376, 378 operably coupled to the cushion pan 64. As with the jounce paddles 76, 78, the pair of lattice-shaped support inserts 376, 378 are symmetrically disposed along either side of a longitudinal centerline C of the vehicle seating assembly. Preferably, a gap W separates each of the lattice-shaped support inserts 376, 378 along the longitudinal centerline C of the vehicle seating assembly 10, as shown in FIG. 27.

The pair of lattice-shaped support inserts 376, 378 is preferably fabricated of a lightweight polymeric three-dimensionally printed component, such as EPU 40, a high performance polyurethane elastomer that offers high elasticity, resilient, and tear resistance. Preferably, the pair of lattice-shaped support inserts 376, 378 comprises a compressible cuboid disposed between the cushion foam assembly 42 and the cushion pan 64, where each of the lattice-shaped support inserts 376, 378 is about 75 mm wide transverse to the longitudinal centerline C of the vehicle 6 and about 75 mm long parallel to longitudinal centerline C of the vehicle 6 so as to provide adequate support to the back of each of an occupant's thighs. The lattice-shaped support inserts 376, 378 are preferably about 35 mm thick (taken in the Z direction).

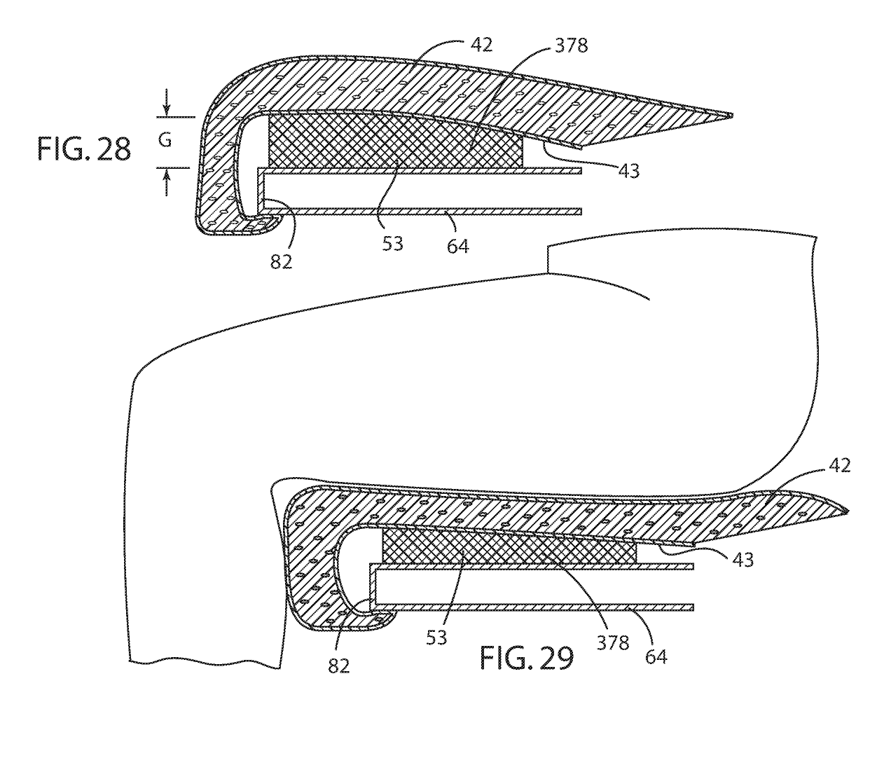

As shown in FIG. 27, each of the lattice-shaped support inserts 376, 378 has significant interstitial spaces or voids 380, within which the fibers 382 of the lattice-shaped support inserts 376, 378 may flex and provide a pair of resilient independent thigh supports 51, 53 that assembles directly to the cushion pan 64. That is, the fibers 382 of the lattice-shaped support inserts 376, 378 are displaced and the entirety of the pair of lattice-shaped support inserts 376, 378 is compressed under load, and the vertical gap G between the underside 43 of the cushion foam assembly 42 and a forward edge 82 of the cushion pan 64 is reduced, as shown in comparing FIGS. 28 and 29.

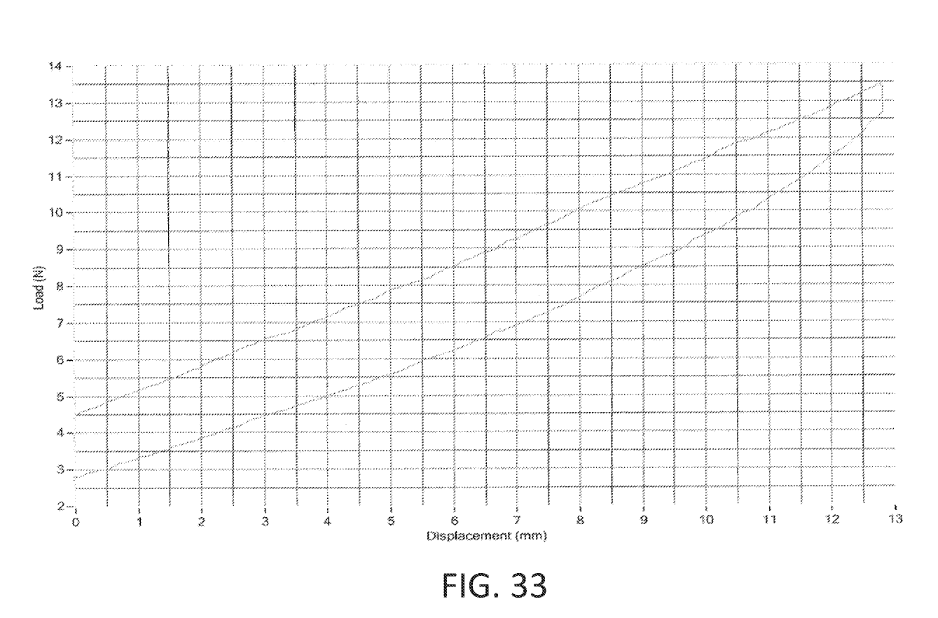

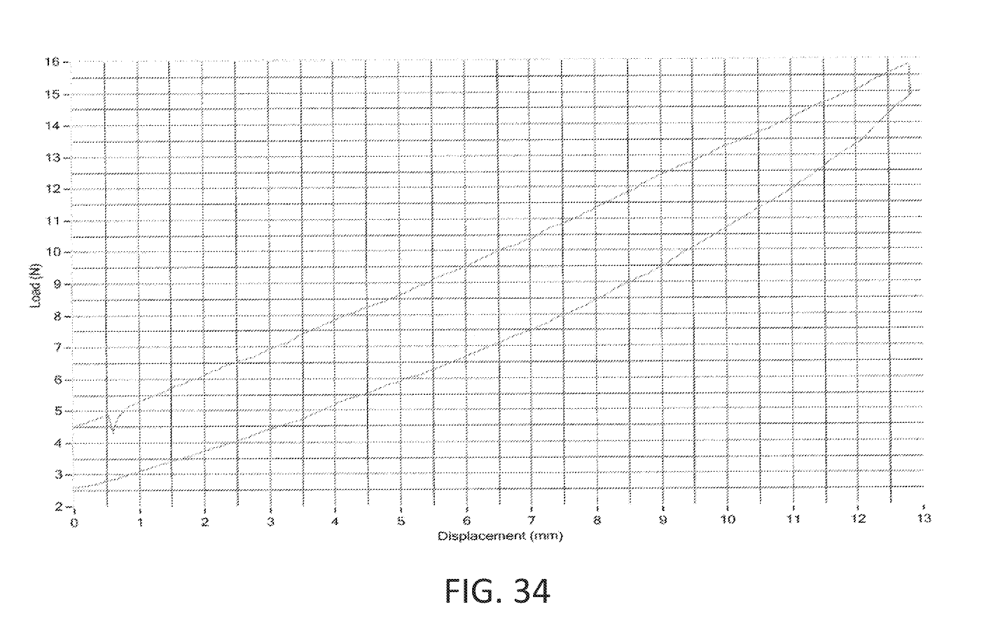

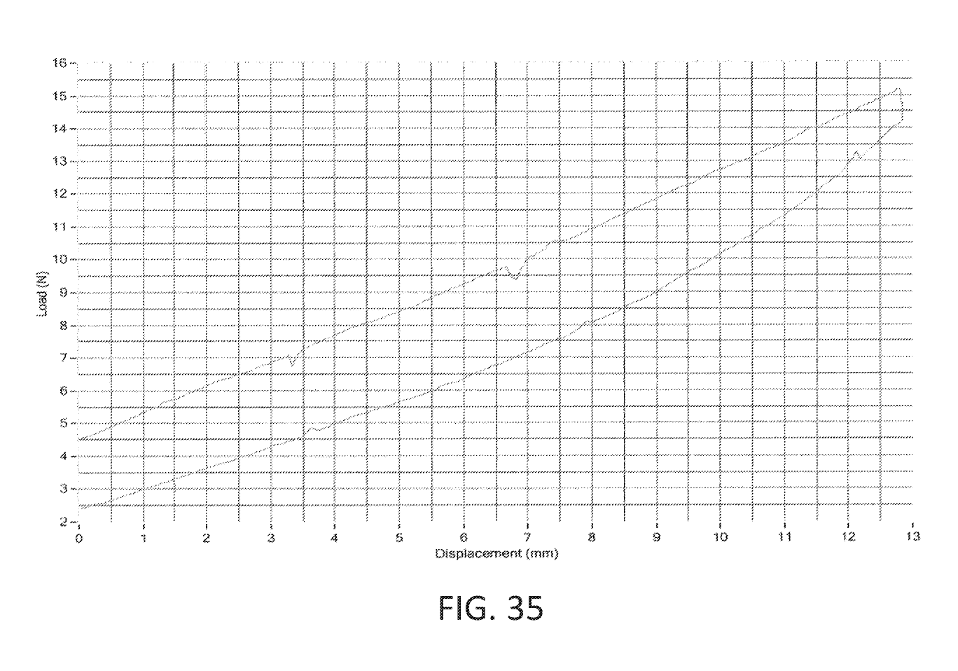

The pair of lattice-shaped support inserts 376, 378 preferably has the predetermined hysteresis support-curve shown in the load deflection curve presented in FIGS. 33-35 to provide independent and resilient support for each thigh of an occupant's legs. The pair of lattice-shaped support inserts 376, 378 thus provides passive supports that are capable of acting independently under the load of each leg, and thereby reduce leg muscle fatigue and provide support for important vehicle functions, especially such as acceleration and braking with the right leg and manual gear shift or relaxation on the left leg.

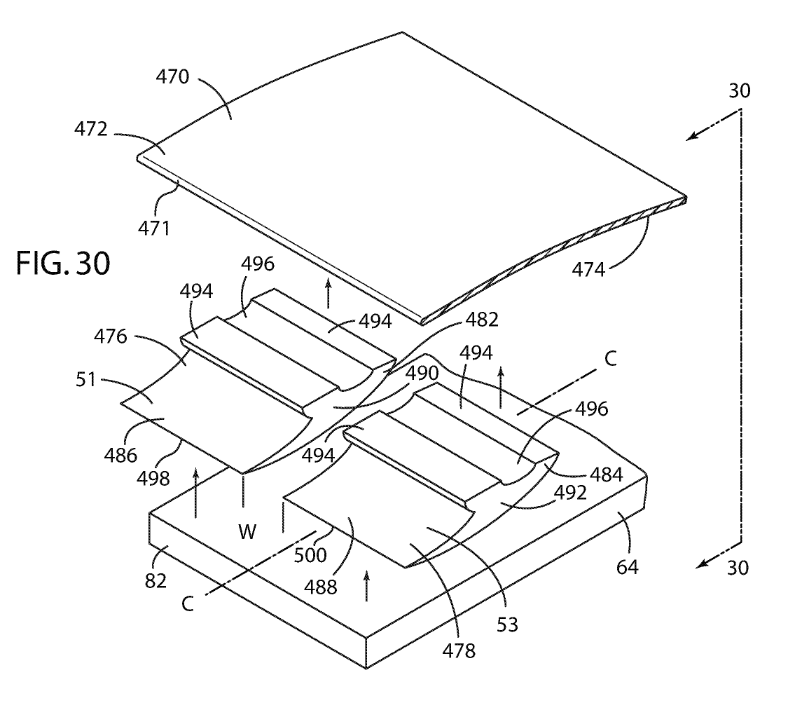

A third embodiment of the independent thigh supports 51, 53 is shown in FIGS. 30, 31, and 32. There, the lower seat 12 further also includes a contact substrate 470 having an upper surface 472 and a lower surface 474 disposed below the underside 43 of the cushion foam assembly 42 and the pair of independent thigh supports 51, 53 comprises a pair of spring elements 476, 478 in contact with each of the contact substrate 470 and the cushion pan 64. The upper surface 472 of the contact substrate 470 is disposed below and in juxtaposed relation with the cushion foam assembly 42.

Preferably, the contact substrate is mechanically coupled with the cushion foam assembly 42 via an adhesive or other fastening technique and mechanically coupled with the cushion pan via a fastener 480. Alternatively, the contact substrate 470 may be molded in situ along with the cushion foam assembly 42 to provide a reliable bond. As shown in FIG. 30, the pair of spring elements 476, 478 is symmetrically disposed along either side of a longitudinal centerline C of the vehicle seating assembly 10, and a gap W separates each of the spring elements 476, 478 along the longitudinal centerline C of the vehicle seating assembly 10.

Preferably, the pair of spring elements 476, 478 each comprises a shaped polymeric or elastomeric member having a base 482, 484 in contact with the contact substrate 470 and a resilient curvilinear cantilevered arm 486, 488 extending from the base 482, 484 in contact with the cushion pan 64. The base 482, 484 of the pair of spring elements 476, 478 is operably coupled with the lower surface 472 of the contact substrate 470 in juxtaposed relation with the cushion foam assembly 42 and the pair of resilient curvilinear cantilevered arms 486, 488 is operably coupled with the cushion pan 64. In the embodiment shown, the resilient curvilinear cantilevered arms 486, 488 of the pair of the spring elements 476, 478 each extend from a lower portion 490, 492 of the base 482, 484. Preferably, each of the bases 482, 484 includes a pair of legs 494 separated by a space 496 that allows the base 482, 484, along with the resilient curvilinear cantilevered arms 486, 488 as discussed below, to be displaced and compressed under load, as shown in FIG. 32, to provide additional resiliency to the pair of spring elements 476, 478.

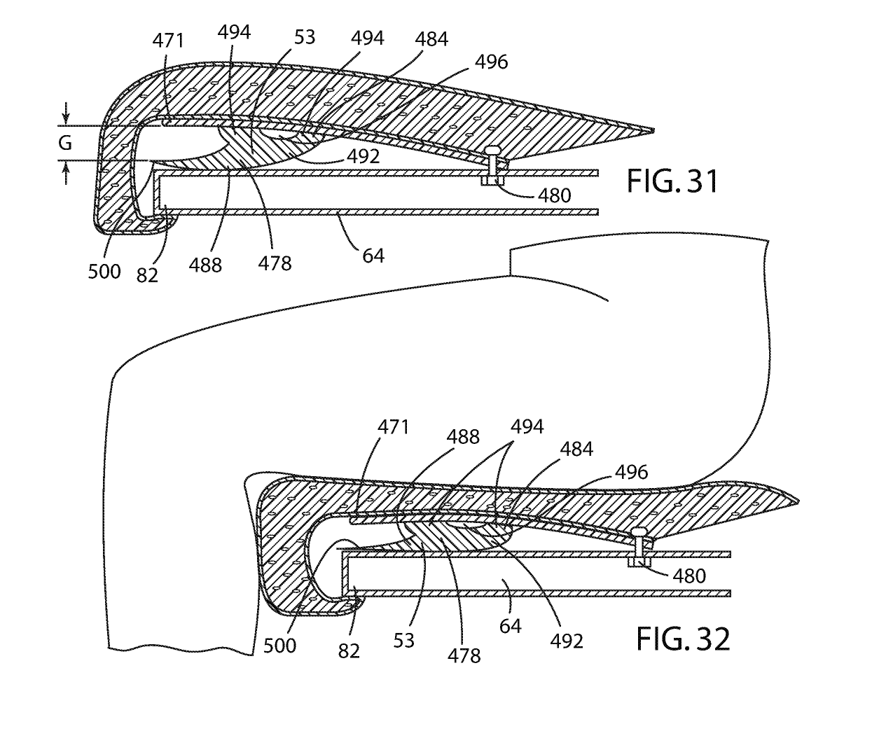

The resilient curvilinear cantilevered arms 486, 488 of the pair of spring elements 476, 478 extend forward from the base 482, 484 at an acute angle and are in contact with the cushion pan 64 to form a vertical gap G between the distal end 498, 500 of each of the pair of resilient curvilinear cantilevered arms 486, 488 and a forward portion of the contact substrate, as shown in FIGS. 31 and 32. When the seating assembly 10 is occupied by the occupant, the lower seat is loaded with the occupant's thighs, as shown in FIG. 32. As a consequence, the resilient curvilinear cantilevered arms 486, 488 are displaced and compressed under load, and the vertical gap G between the distal end 498, 500 of each of the pair of resilient curvilinear cantilevered arms 486, 488 and a forward portion 471 of the contact substrate 470 is reduced, as shown in comparing FIGS. 31 and 32.

Preferably, the cushion pan 64 and the resilient curvilinear cantilevered arms 486, 488 of the pair of spring elements 476, 478 are fabricated from a durable material that is particularly wear resistant, given that relative movement will occur between the resilient curvilinear cantilevered arms 486, 488 of the pair of spring elements 476, 478 and the cushion pan that will tend to wear on the cushion pan and the underside of the resilient curvilinear cantilevered arms 486, 488 of the pair of spring elements 476, 478.

In a first version of this embodiment, the contact substrate 470 and each of the resilient curvilinear cantilevered arms 486, 488 of the pair of spring elements 476, 478 may be combined as a single integrated molded or extruded component. In a second version of this embodiment, the contact substrate 470 and each of the resilient curvilinear cantilevered arms 486, 488 of the pair of spring elements 476, 478 may be formed as separate molded or extruded components, but subsequently combined as a single integrated assembly, such as through an adhesive or through ultrasonic or laser welding. The pair of spring elements 476, 478 likewise provides passive supports that act independently under the load of each leg, and thereby reduce leg muscle fatigue and provide support for vehicle functions.

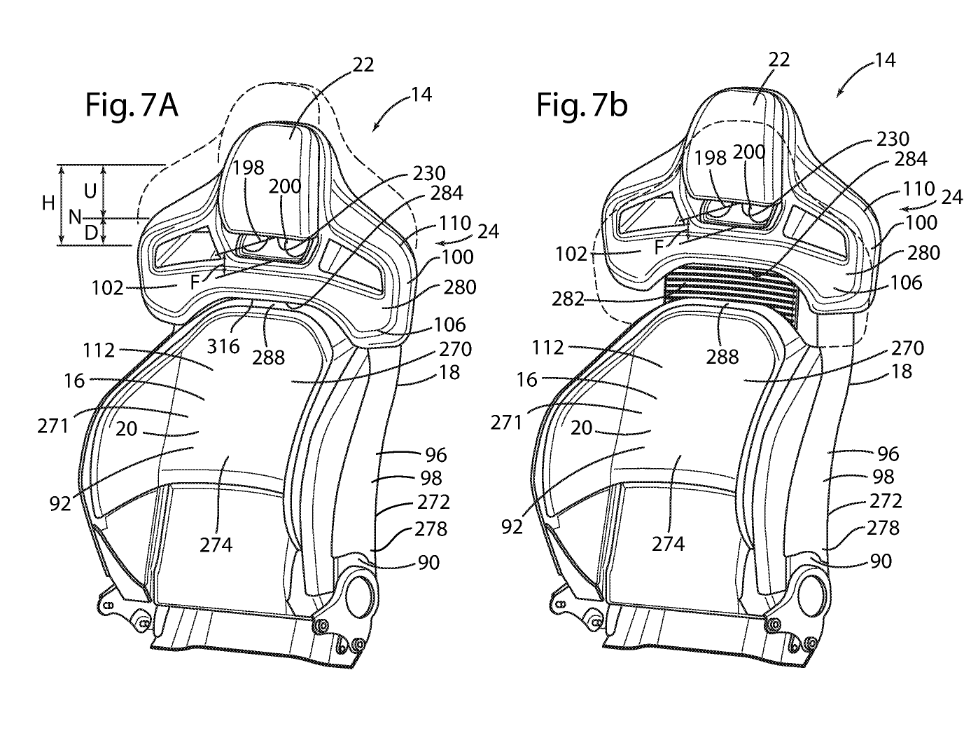

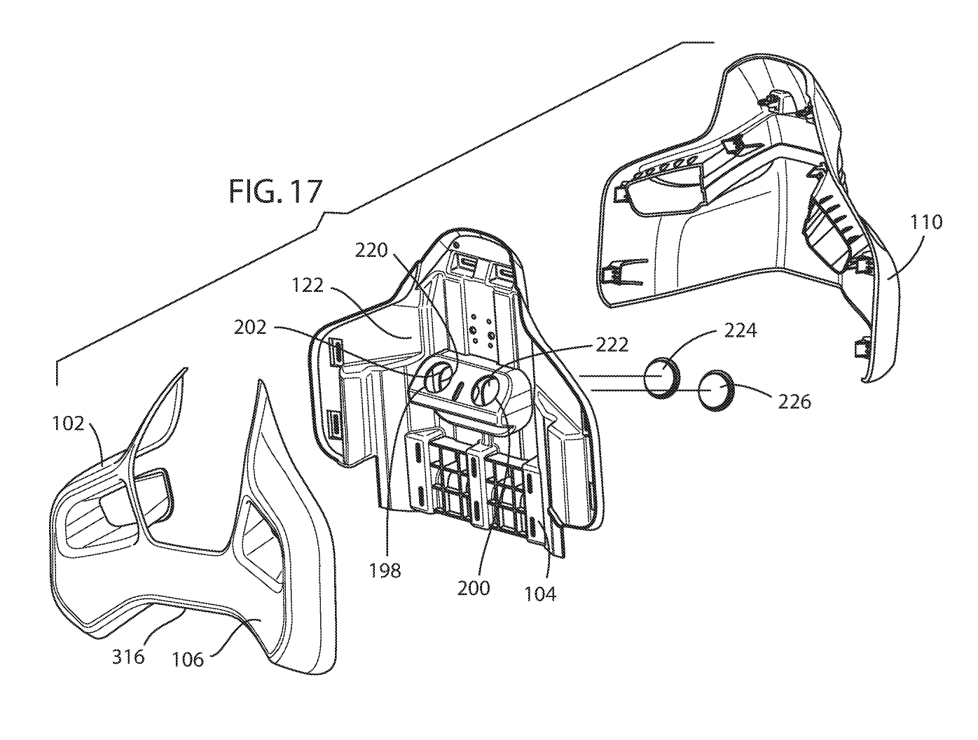

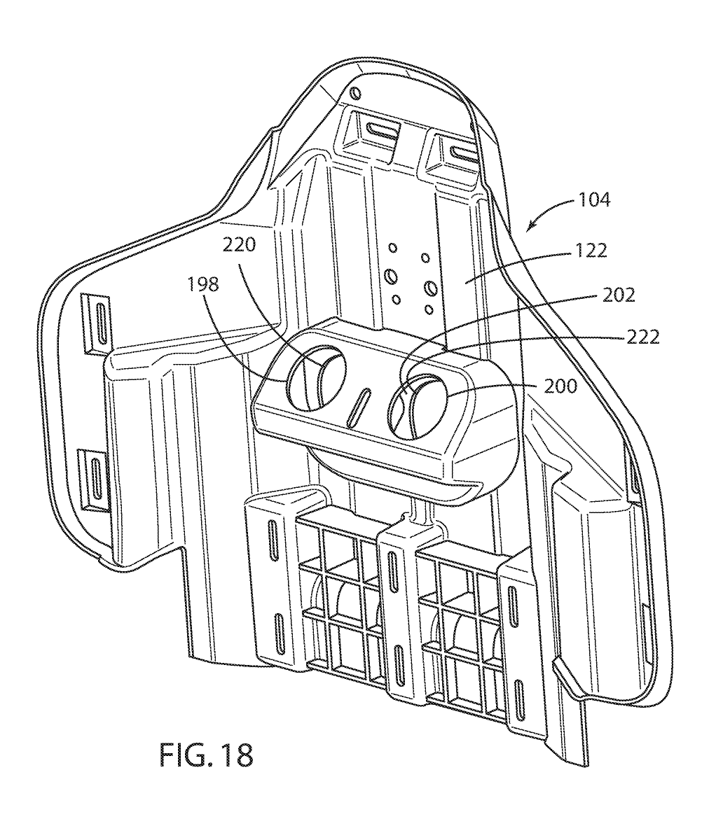

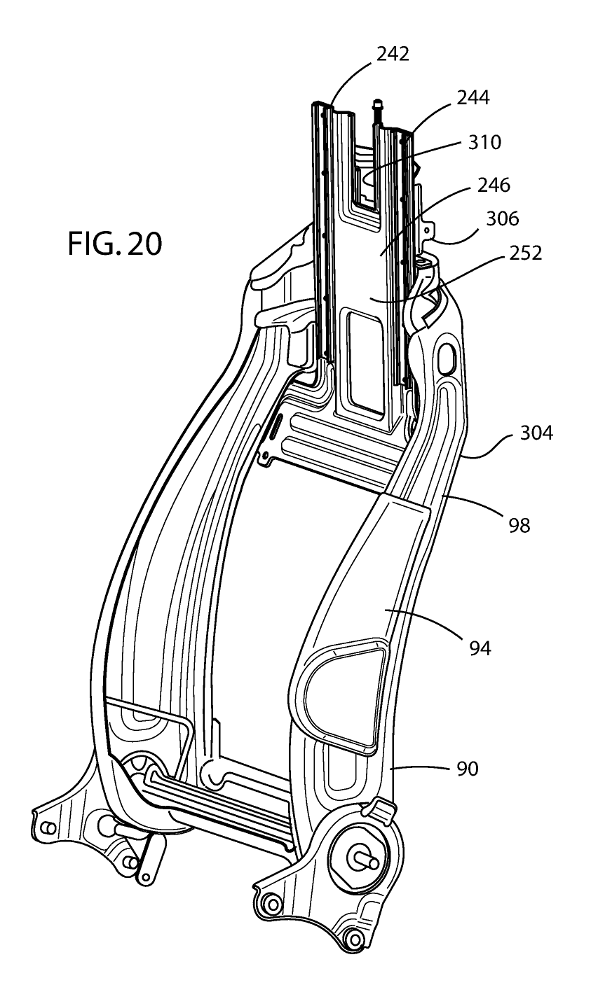

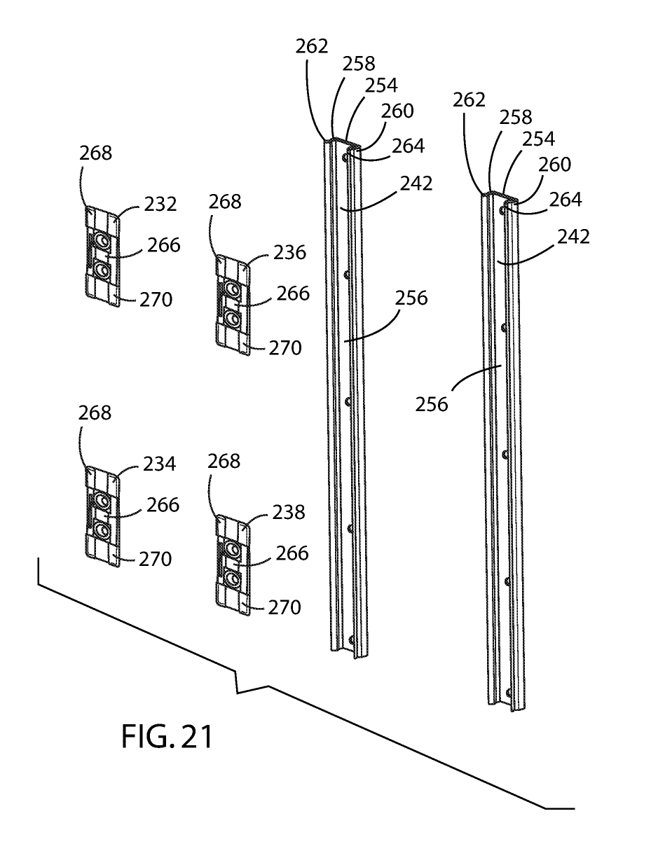

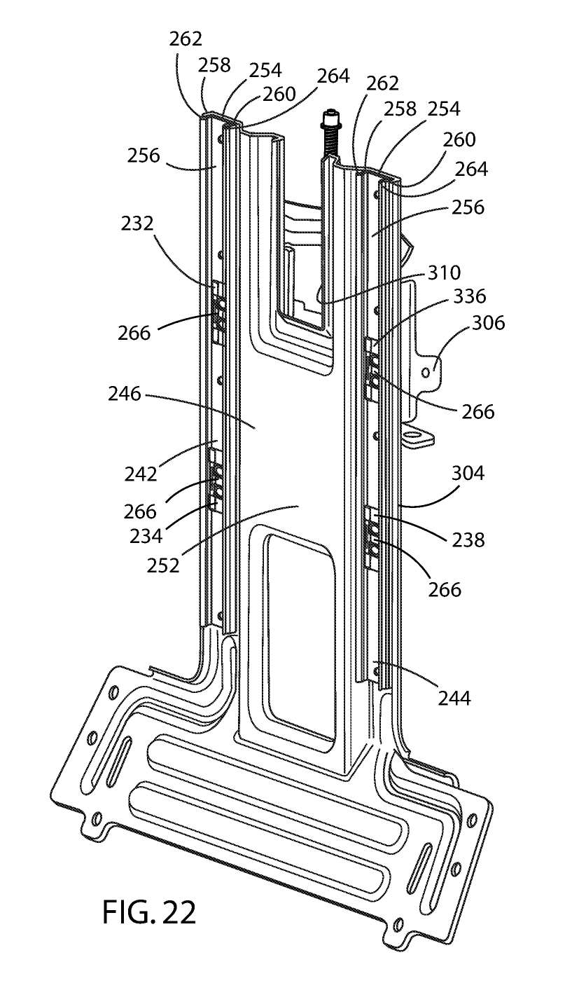

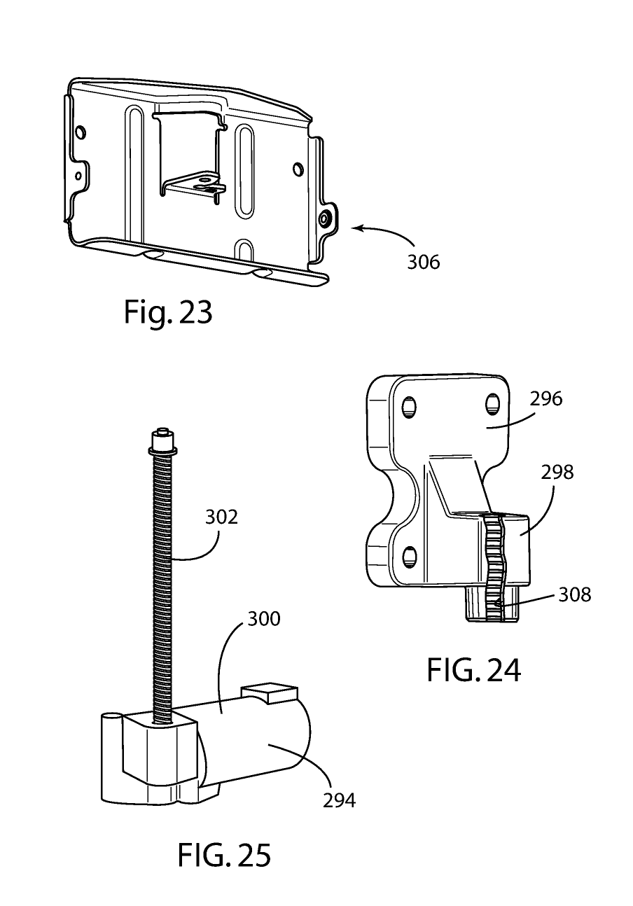

As shown in FIGS. 7A, 7B, 16, 17, and 20, the seatback 14 includes a seatback frame assembly 90, which includes a back carrier 94, a front cushion 92, and a rear trim panel 96 that enclose the seatback frame assembly 90 in a clamshell type arrangement. Preferably, as will be discussed more fully below, the seatback 14 includes a lower stationary seatback base portion 98 and an upper movable seatback hood module 100 that allows the upper portion 24 of the seatback 14 to be raised and lowered in accordance with the occupant's preference and, in particular, to properly locate the headrest 22 and a speaker assembly 196, both addressed in more detail below. The upper movable seatback hood module 100 includes a front upper seatback slide bracket 102 that forms a front of the upper movable seatback hood module 100, rear upper seatback slide bracket 104, hood foam 106, and a hood back trim panel 110. The front upper seatback slide bracket 102 and hood back trim panel 110 enclose the rear upper seatback slide bracket 104 in a clamshell-type arrangement, as shown in FIG. 17.

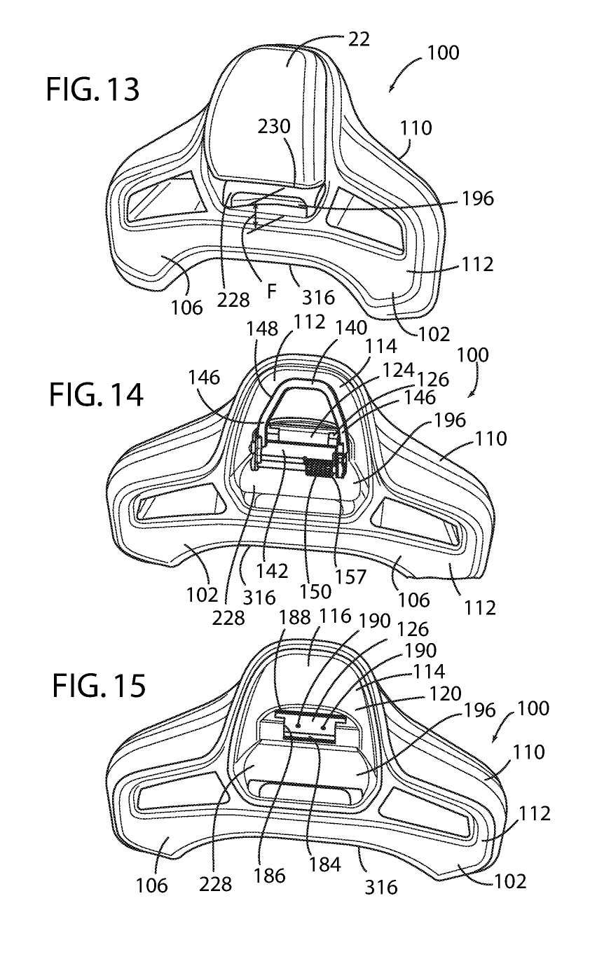

The forward facing surface 112 of the upper portion 24 of the seatback 14 includes a central recess 114 that corresponds with and receives a headrest cup 116. The headrest cup 116 is preferably formed as a polymeric shell mounted within the central recess 114 and on the forward facing surface 112 of the seatback 14 and is disposed in front of a forward surface 122 of the rear upper seatback slide bracket 104. In turn, the headrest 22 is received within a recess 120 of the headrest cup 116 disposed on the forward facing surface 112 of the seatback 14. As shown in FIG. 13, the headrest 22 is thereby mounted within the upper movable seatback hood module 100 on the upper portion 24 of the seatback 14.

In particular, in the case of high-performance seats installed in motor vehicles that are designed for racing and motor track use, it is often required that the occupants, especially the driver, wear a helmet or other type of protective headgear adapted to protect the head of the occupant. However, existing headrests are often in the way and tend to push the head of the driver forward to uncomfortable positions due to the bulk of existing headrests. While such headrests can often be removed, rear head support is likewise removed. In the case of performance seats that are intended to be used in racing or sporting applications, this is especially unacceptable. Instead, what was needed was a performance seat that was adaptable to accommodate racing helmets and head gear, especially in the head region where movement and viewing flexibility is most needed, while also providing adequate support.

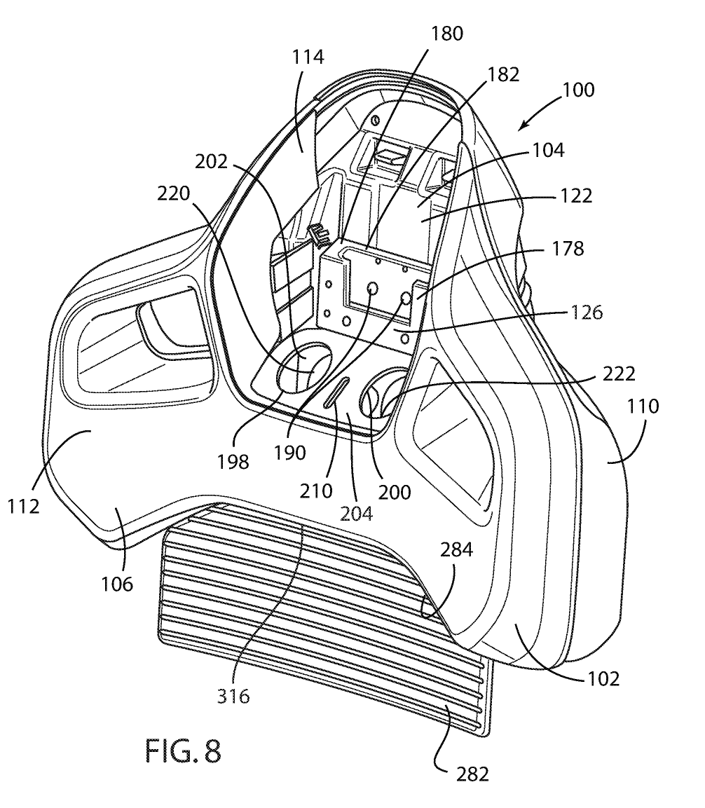

Accordingly, the present disclosure provides a headrest 22 that can be easily assembled and installed in the seatback 14, as well as be readily removable and reinstalled without the need for tools or adjustment. The headrest 22, that further provides a pivoting adjustment mechanism and supporting structure, as discussed below, may be readily attached to the upper portion 24 of the seatback 14 by means of a “dovetail” design to secure it in place, yet allow the headrest 22 to be readily removed for racing or motor track use or service requirements and readily reinstalled. That is, as shown in FIGS. 8, 9B, and 13-16, the headrest 22 is mounted to the forward surface 122 of the rear upper seatback slide bracket 104 via a headrest dovetail 124 that is removably received within a dovetail receiver 126 mounted to the rear upper seatback slide bracket 104. Preferably, the headrest may be articulated forward and backward around a pair of pivots 128 near its base 130 and the headrest 22 can be entirely removed from the seatback 14, as discussed below.

The headrest 22 disclosed herein avoids the problems of existing headrests by being installed within the headrest cup 116 and by being readily removable and reinstallable, thereby allowing the headrest 22 to be removed from the seatback 14 to expose the headrest cup 116 within which the driver's or passenger's helmet can be received. The present disclosure avoids the disadvantages of prior removable headrest designs and replaces the posts that extend downwardly to allow the vertical adjustment for the headrest 22 height with a dovetail attachment mechanism. With the headrest 22 simply removed from the seatback 14, as is discussed further detail below, an ample cavity is formed within which a helmet or other headgear may be received to allow the driver and/or passenger to occupy the seat with relative comfort. In such a case, the headrest cup 116, even with the headrest 22 removed, still offers head and neck support in the event of a rear impact to minimize whiplash and other injuries. In this regard, it is further noted that the headrest cup 116 is preferably lined with a rubber padding 132, so that with the headrest 22 removed, any jostling or other contact of the occupant's helmet or headgear with the headrest cup 116 is dampened and minimized.

The headrest 22 includes a headrest cover 134 that encases the headrest 22, which further includes a headrest front foam member 136, an EPP foam member 137, a headrest mechanism 138 comprising a generally U-shaped tubular member 140 and a rear mounting base plate 142, and a rear foam member 144. Preferably, the U-shaped tubular member 140 and the rear mounting base plate 142 are fabricated from steel. The U-shaped tubular member 140 comprises two vertically and upwardly extending arms 146 that each engages a respective right and left end of an upwardly and rearwardly tilted U-shaped support 148 for providing rigid structural support to the headrest 22, as shown. The U-shaped tubular member 140 is pivotally mounted to the rear mounting base plate 142 by the pair of opposed pivots 128, one of which includes a spring-loaded ratchet mechanism 150, as shown in FIG. 12, which in one embodiment normally urges the headrest 22 to a forward position by a spring 151. In use, the headrest 22 can be pivoted forward from a maximum rearward position in discrete increments by the action of a pawl 152 engaging a cam 154 until reaching a maximum forward position. After reaching the maximum forward position, the pawl 152 is released from the cam 154 to release the ratchet mechanism 150 which, in turn, releases and allows the return of the headrest 22 to its rearward position. While the headrest 22 shown herein is intended for manual adjustment, it is contemplated that a motor and quick disconnect for the power to the motor (not shown) can be provided to facilitate ready removal of the headrest 22 from the seatback 14 and reinstallation thereof.

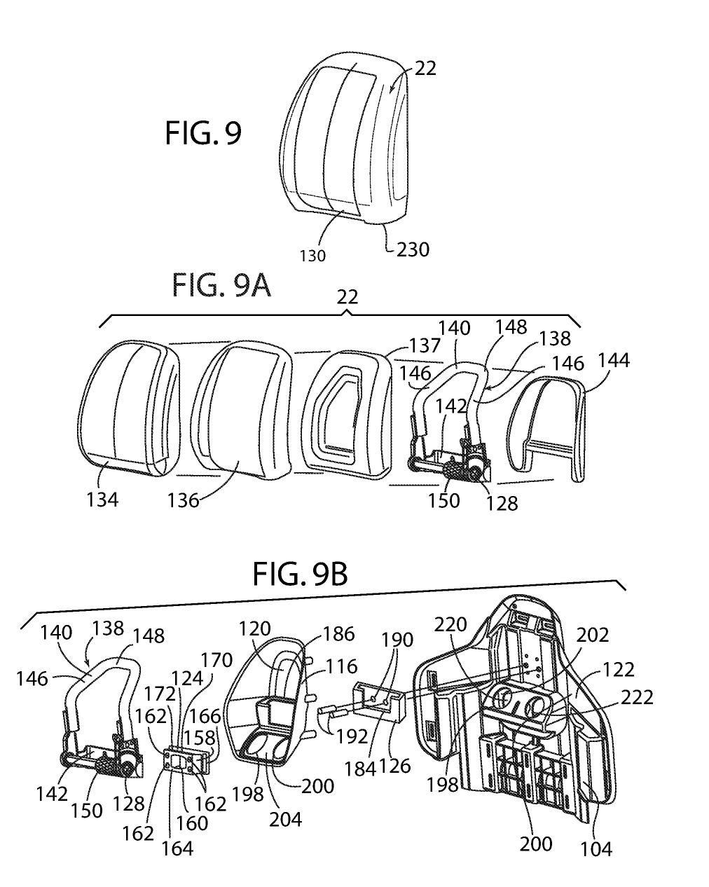

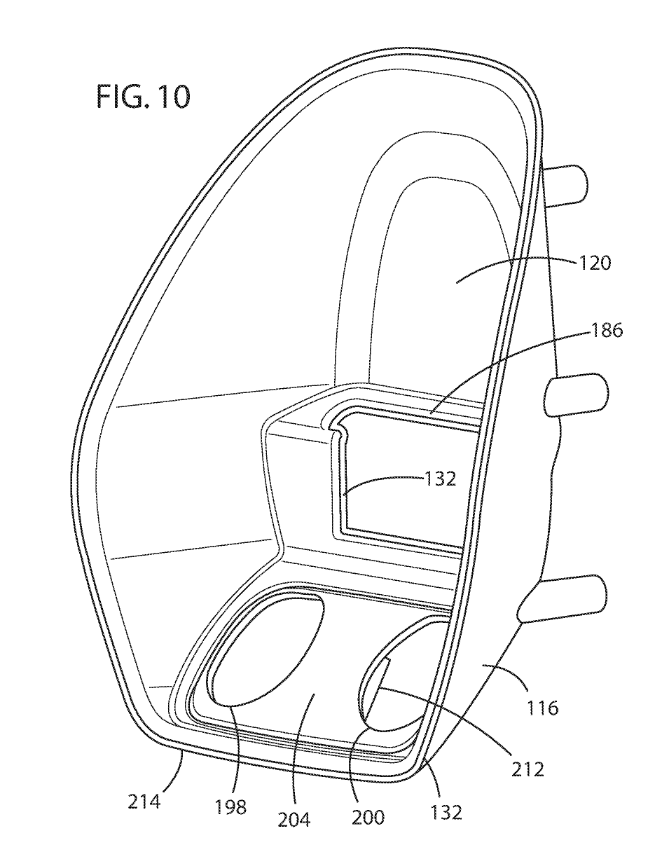

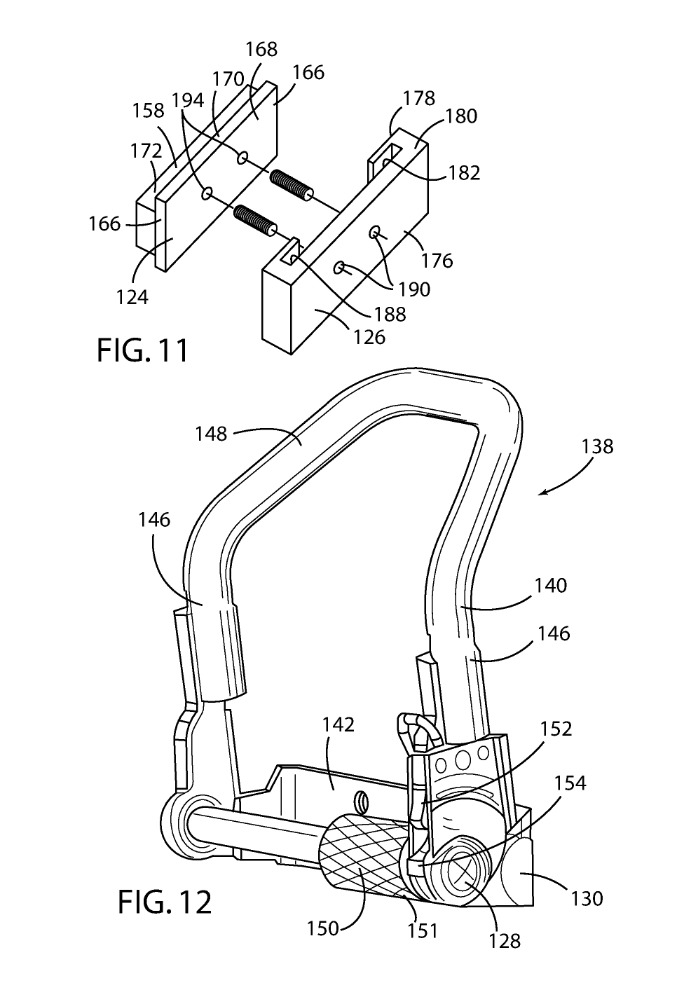

As shown in FIGS. 9B and 11, the dovetail attachment mechanism includes the headrest dovetail 124 mounted to the rear of the headrest 22, in particular to the rear mounting base plate 142, via a plurality of mechanical fasteners, as is known in the art. The headrest dovetail 124 comprises a rectangular block member 158 that preferably has a cavity 160 formed in a central portion thereof to minimize weight. A plurality of mechanical fastener openings 162 is provided on a forward surface 164 of the rectangular block member 158 about the cavity 160 to facilitate attachment of the rectangular block member 158 to the rear mounting base plate 142 of the headrest 22. A pair of laterally engaging tabs 166 extends laterally in both side directions beyond the lateral dimensions of the rectangular block member 158 proximate a rear surface 168 of the headrest dovetail 124. An upper edge 170 extends slightly above an upper surface 172 of the rectangular block member 158.

The dovetail receiver 126, best shown in FIGS. 9B, 11, and 16, is mounted to the forward surface 122 of the rear upper seatback slide bracket 104 via a plurality of conventional mechanical fasteners. That is, the dovetail receiver 126 has a rear surface 176 that is juxtaposed with the forward surface 122 of the rear upper seatback slide bracket 104 and is rigidly attached thereto. A forward surface 178 and an upper surface 180 of the dovetail receiver 126 are provided with an opening that forms a T-shaped slot 182. The T-shaped slot 182 has a lateral width on the upper surface 180 that exceeds the lateral width of the forward surface 178. The T-shaped slot 182 is thus formed on the forward surface 178 and upper surface 180 of the dovetail receiver 126. A lower surface within the T-shaped slot 182 forms a bottom shoulder 184 thereof.

A T-shaped slot 186 in the headrest cup 116 is shaped to conform to the shape of the T-shaped slot 182, the headrest cup 116 concealing the remaining structure of the dovetail receiver 126 in order to provide an aesthetically pleasing appearance, as shown in FIG. 15. The dovetail receiver 126, so situated relative the T-shaped slot 186, is adapted to receive the laterally engaging tabs 166 of the headrest dovetail 124 as the headrest dovetail 124 is slid downwardly through the T-shaped slot 186 and into an upper opening 188 of the T-shaped slot 182 in the dovetail receiver 126 from above until bottoming out on the bottom shoulder 184. With the laterally engaging tabs 166 of the headrest dovetail 124 so inserted into the T-shaped slot 182, the headrest 22 is rigidly attached to the headrest dovetail 124 and may thereby be securely installed in the central recess 114 of the seatback 14.

The T-shaped slot 182 in the dovetail receiver 126 is further provided with a pair of recesses 190 within which a pair of spring-loaded roller bearings 192 is mounted. A matching pair of indented dimples 194 is provided in the rear surface 168 of the headrest dovetail 124 and is aligned with each of the spring-loaded roller bearings 192 when the headrest 22 is installed. With the indented dimples 194 so aligned with and engaged by the spring-loaded roller bearings 192, the spring-loaded roller bearings 192 are resiliently urged into the indented dimples 194 and secure the headrest dovetail 124 within the T-shaped slot 182 of the dovetail receiver 126. However, by simply exerting a moderate upward force on the headrest 22, the spring-loaded roller bearings 192 can be urged rearwardly, so as to release their engagement with the indented dimples 194. The headrest dovetail 124 can thereby be easily detached from the T-shaped slot 182 of the dovetail receiver 126 for removal of the entire headrest 22 from the seatback 14. Thus, the headrest 22 can be readily removed from the seatback 14 without the use of tools or the need for adjustment. Similarly, the headrest 22 can be readily reinstalled into the headrest cup 116 of the seatback 14 again without the use of tools or the need to perform any types of adjustment.

It should be noted that the disclosed embodiment for mounting the headrest 22 to the upper portion 24 of the seatback 14 itself provides no vertical adjustment of the headrest 22 relative to the upper portion 24 of the seatback 14. Rather, as set forth the below, the height of the headrest 22 can be adjusted by adjustment of the upper portion 24 of the seatback 14. This is particularly advantageous in that existing headrest assemblies using adjustable posts are typically movable within a vertical range of about 50 cm. However, since the upper portion 24 of the seatback 14 of the present disclosure, as further discussed below, is adapted to move within a range H of 75 mm, as shown in FIG. 7A, the headrest 22 disclosed herein is provided with even greater adjustability.

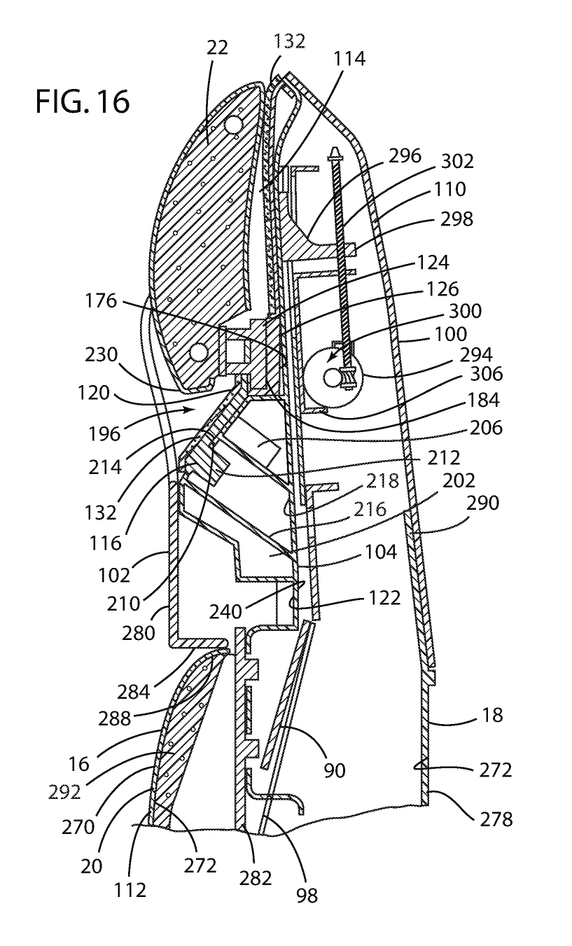

In addition, as shown in FIGS. 13, 14, and 15, a speaker assembly 196 is mounted proximate the bottom of the headrest cup 116 via a pair of speaker openings 198, 200 through both the headrest cup 116 and rear upper seatback slide bracket 104 that receive a pair of speakers 206 shown in FIG. 16. The speaker assembly 196 can include traditional woofer and tweeter systems to more recent piezo-electric speaker systems. Preferably, the speakers include dual 7.5-watt drivers.

A resonance cavity 202 is formed proximate to and just below the headrest cup 116, preferably within the rear upper seatback slide bracket 104, within which the speaker assembly 196 is received. The resonance cavity 202 comprises an enclosed volume, preferably about 290 cm³. Since the resonance cavity 202 is formed in the rear upper seatback slide bracket 104, it is thus enclosed within the seatback 14 between the front upper seatback slide bracket 102 and hood back trim panel 110.

The pair of speaker openings 198, 200 is preferably arranged in side-by-side relation on the lower portion 204 of the headrest cup 116 and the speaker assembly 196 comprises the pair of speakers 206, each received and mounted within one of the pair of speaker openings 198, 200. The pair of speaker openings 198, 200 opens into the headrest cup 116 disposed on the lower portion 204 of the headrest cup 116. As shown in FIG. 8, a slot 210 is formed between the pair of speaker openings 198, 200, the slot 210 being provided to receive a clip 212 depending from a bottom surface 214 of the polymeric shell of the headrest cup 116 by which the polymeric shell of the headrest cup 116 is partially attached to the seatback 14. It has been found that a positive and rigid attachment of the polymeric shell of the headrest cup 116 to the seatback 14 proximate the speakers 206 prevents undesired vibration of the polymeric shell of the headrest cup 116 when the speakers volume is raised. Further, the slot 210 is sealed from the resonance cavity 202 by an enclosed cap 216 extending downwardly from the slot 210 into contact with the rearward surface 218 of the resonance cavity 202.

The resonance cavity 202 further includes a pair of passive radiator openings 220, 222 arranged in side-by-side relation and disposed on a rear surface 240 of the rear upper seatback slide bracket 104, within which each one of a pair of the passive radiators 224, 226 is received. The pair of passive radiator openings 220, 222 forms rearward facing openings. The pair of passive radiators 224, 226 each comprises a circular elastomeric diaphragm.

A headrest cup speaker grill 228 is disposed above the speaker openings 198, 200 and below the headrest 22, and a forward facing gap F is provided between the headrest cup speaker grill 228 and a lower portion 230 of the headrest 22, as shown in FIG. 7B. The headrest cup speaker grill 228 is comprised of a thin gauge perforated metal mesh. Preferably, the perforated metal mesh is comprised of aluminum mesh about 0.005 inches in thickness.

As noted above, the seatback 14 includes the lower stationary seatback base portion 98 and an upper movable seatback hood module 100 that allows the upper portion 24 of the seatback 14 to be raised and lowered in accordance with the customer's preference and, in particular, to properly locate the headrest 22 and the speaker openings 198, 200. The lower stationary seatback base portion 98 is supported by the seatback frame assembly 90, while the upper movable seatback hood module 100 is vertically adjustable relative the lower stationary seatback base portion 98 and is supported by the front upper seatback slide bracket 102 in cooperation with the rear upper seatback slide bracket 104.

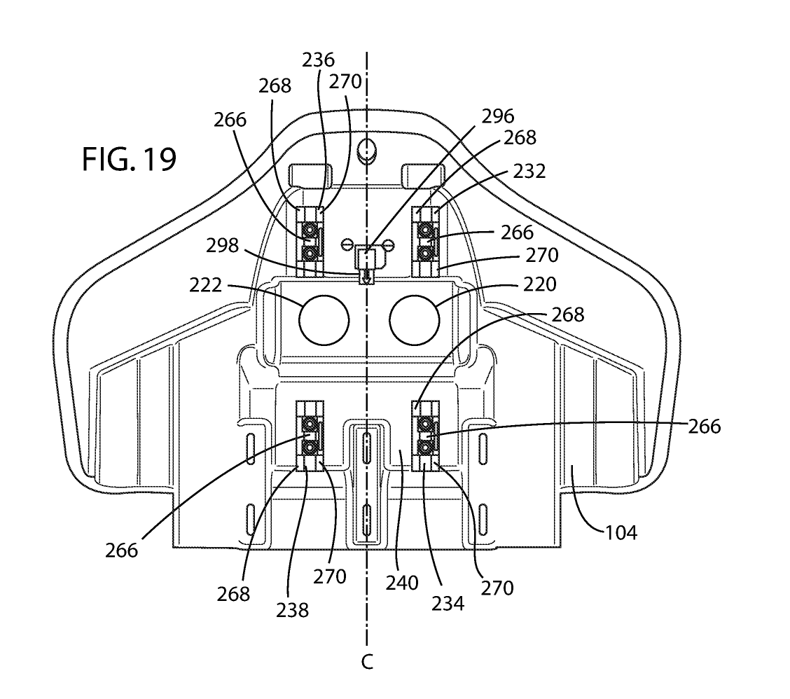

Preferably, a set of four rail guides 232, 234, 236, 238 is mounted to the rear surface 240 of the rear upper seatback slide bracket 104, as shown in FIG. 19. The rail guides 232, 234, 236, 238 are arranged in a generally rectangular orientation in two pairs on each side of the rear upper seatback slide bracket 104 about its centerline C. That is, the plurality of rail guides 232, 234, 236, 238 are mounted to the rearward facing surface 240 of the rear upper seatback slide bracket 104 in a pair of rows on the rearward facing surface 240 of the rear upper seatback slide bracket 104 and on opposite sides of and relative the centerline C thereof.

The rail guides 232, 234, 236, 238 are in turn engaged by a pair of slide rails 242, 244 mounted to a back frame bracket 246. The pair of slide rails 242, 244 is mounted in abutting relation with a forward facing surface 252 of the back frame bracket 246. Each of the slide rails 242, 244 has a base 254 in parallel relation with a forward facing surface 256 of the seatback frame assembly 90, a pair of cooperating legs 258, 260 extending orthogonally from the base 254 and a pair of opposing tabs 262, 264 extending orthogonally from the cooperating legs 258, 260 in a plane parallel to the base 254. Likewise, each of the rail guides 232, 234, 236, 238 has a base 266 in parallel relation with the rearward facing surface 240 of the rear upper seatback slide bracket 104 and a pair of ears 268, 270 extending outwardly from the base 266, the pair of ears 268, 270 being displaced from the rearward facing surface 240 of the rear upper seatback slide bracket 104 and slidingly engaged on either side by the opposing tabs 262, 264 of the slide rails 242, 244. Each of the rail guides 232, 234, 236, 238 thereby slidingly engages one of the slide rails 242, 244.

Although the preferred embodiment has been described, it should be noted that the plurality of rail guides 232, 234, 236, 238 may be mounted to either of one of the seatback frame assembly 90 or the front upper seatback slide bracket 102 and the rail may be mounted to the other of the seatback frame assembly 90 or the front upper seatback slide bracket 102, so long as the slide rails 242, 244 slidably engage the plurality of rail guides 232, 234, 236, 238.

As shown in FIGS. 7A, 7B, and 16, the lower stationary seatback base portion 98 comprises a forward facing surface 271 and a rearward facing surface 272. The forward facing surface 271 includes a lower seatback cushion 274 having an outer covering 276, while the rearward facing surface 272 comprising a semi-rigid lower back panel 278 extending upwardly relative the lower stationary seatback base portion 98. The upper movable seatback hood module 100 also includes a forward facing hood covering 280, an upper closeout panel 282 attached to a bottom portion 284 of the upper movable seatback hood module 100 beneath the forward facing hood covering 280, and the rearward-facing hood back trim panel 110.

Preferably, in order to present a pleasing appearance at all times, the upper closeout panel 282 extends downwardly behind and below an upper edge 288 of the lower seatback cushion 274 when the upper movable seatback hood module 100 is moved to an upmost raised position. Likewise, the rearward facing hood back trim panel 110 extends downwardly below an upper edge 290 of the upwardly extending lower back panel 278 when the upper movable seatback hood module 100 is moved to the upmost raised position. Also, the forward portion of the lower stationary seatback base portion 98 includes the forward facing surface 271, a back foam cushion 292, and the seatback frame assembly 90, wherein the upper closeout panel 282 extends downwardly and is vertically displaceable within a space defined between the forward facing surface 112 and back foam cushion 292 and the seatback frame assembly 90.

An electric motor drive unit 294 is mounted on one of the seatback frame assembly 90 or the rear upper seatback slide bracket 104, and is operatively coupled with the other of the seatback frame assembly 90 or the rear upper seatback slide bracket 104, as shown in FIG. 16. The electric motor drive unit 294 thus may vertically adjust the upper movable seatback hood module 100 relative the lower stationary seatback base portion 98 when the electric motor drive unit 294 is actuated.

Preferably, the electric motor drive unit 294 is mounted on the seatback frame assembly 90 and a driven member 296 is mounted on the rear upper seatback slide bracket 104, as shown in FIG. 16. The driven member 296 preferably comprises a motor nut 298, and the electric motor drive unit 294 further comprises an electric motor 300 with a threaded output shaft 302 that engages the motor nut 298 to vertically adjust the upper movable seatback hood module 100 relative the lower stationary seatback base portion 98 when the electric motor drive unit 294 is actuated.

Preferably, the electric motor 300 is mounted to a rearward facing surface 304 on back frame bracket 246, which is in turn rigidly attached to the seatback frame assembly 90 that forms the supporting structure for the lower stationary seatback base portion 98 of the seatback 14. The electric motor 300 preferably is mounted to the back frame bracket 246 via a back frame reinforcement bracket 306 and thereby engages and selectively drives the vertically extending threaded output shaft 302.

An upper portion of the vertically extending threaded output shaft 302 is received within a threaded opening 308 within the motor nut 298, where the motor nut 298 is in turn rigidly attached to the rearward facing surface 240 of the rear upper seatback slide bracket 104. When the electric motor 300 is actuated, the rotation of the vertically extending threaded output shaft 302 drives the motor nut 298 upward or downward, depending on the initial position and direction of rotation. A slot 310 in the back frame bracket 246 allows the motor nut 298 to move upwardly and downwardly relative the back frame bracket 246. As the motor nut 298 is rigidly mounted to the rear surface 240 of the rear upper seatback slide bracket 104, the upper movable seatback hood module 100 is moved either upwardly or downwardly, again depending upon its initial position and the direction of rotation, relative the lower stationary seatback base portion 98. Thus, the interaction of the rail guides 232, 234, 236, 238 with the slide rails 242, 244 allows for the upper movable seatback hood module 100 to rise and lower relative to the lower stationary backseat base portion 98 of the seatback 14.

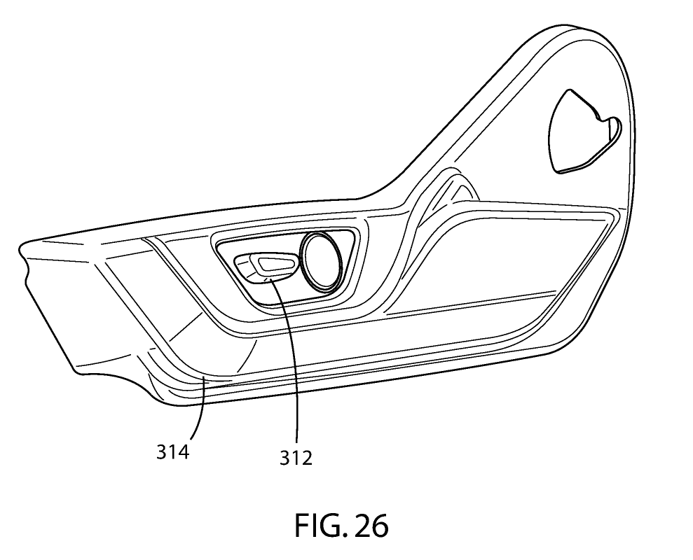

Although the electric motor 300 is preferably disclosed as being mounted on the seatback frame assembly 90 and the driven member 296 is mounted on the rear upper seatback slide bracket 104, the components can be reversed. That is, the electric motor drive unit 294 may be mounted on the rear upper seatback slide bracket 104, and the driven member 296 may be mounted on the seatback frame assembly 90. A switch 312 with which to actuate the electrical motor 300 may be disposed on an outboard trim panel 314 of the seat assembly, as shown in FIG. 26.

Based on the 50^{th} percentile adult male model, the upper movable seatback hood module 100 has a neutral position N, as shown in FIG. 7A, wherein the headrest 22 and the speakers 206, 208 are located at the optimum position relative the occupant's head and ears. Further, a vertical gap D is defined between a lower edge 316 of the forward facing hood covering 280 and the upper edge 288 of the lower seatback cushion 274. Preferably, the upper movable seatback hood module 100 is thus displaceable from the neutral position N to a lowermost lowered position, where the vertical height between the lowermost lowered position and the neutral position N is about 10 mm. Preferably, the upper movable seatback hood module 100 is also displaceable from the neutral position N to an upmost raised position over a vertical gap U, where the vertical height between the lower edge 316 and the upper edge 288 and thus between the upmost raised position and the neutral position N is about 65 mm. Thus, preferably, the total vertical height H between the lower edge 316 and the upper edge 288 and thus between the upmost raised position and the lowermost lowered position is about 75 mm, thereby providing a wide range of adjustment heights to accommodate occupants of different heights and builds. That is, this embodiment provides appropriate positioning of the headrest 22 and the speakers 206 relative the occupant's head and may be customized to the particular stature of the occupant. By employing the upper movable seatback hood module 100 of the present disclosure, with a total travel of 75 mm in the vertical direction via an electric motor 300 that moves on multiple slide rails 242, 244 that allows the upper moveable seatback hood module 100, including the headrest 22, to adjust its height to the range of occupant sizes from shortest to tallest statures, the occupant's comfort is enhanced.

In accordance with another feature of the present disclosure, the headrest 22 and speakers 206 are thus placed precisely at the lower ear level of the occupant to enhance the occupant's listening experience and sense of own space. By packaging the speaker assembly 196 in the upper moveable seatback hood module 100, sound and music may be enjoyed close to the occupant's ears and within a central recess 114 of the upper moveable seatback hood module 100 assembly. The acoustics are maximized by the sound waves having short distances to travel. This proximity creates an occupant experience of “live” sounds and clear listening. Particularly in combination with the built-in resonance cavity 202 below the speaker openings 198, 200 and the dual passive radiators 224, 226 positioned at the rear and bottom of the resonance cavity 202, the headrest 22 and speakers 206 location has been found to be optimal for best listening and acoustics.

Further, the disclosed sound system provides to the occupant of the vehicle seating assembly 10 the ability to engage in private communications without using the main cabin speaker system. That is, during the use of integrated, hands-free mobile telephone conversations and vehicle systems that provide text reading capabilities during vehicle operation, the speaker assembly 196 disposed just behind the ears of the occupant allows for lower volumes and thus a more private telephone conversation or text reading experience.

Moreover, it will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the terms “coupled” in all of its forms, couple, coupling, coupled, etc. and “connected” in all of its forms, connect, connecting, connected, etc. generally means the joining of two components electrical or mechanical directly or indirectly to one another. Such joining may be stationary in nature or movable in nature. Such joining may be achieved with the two components electrical or mechanical and any additional intermediate members being integrally formed as a single unitary body with one another or with the two components. Such joining may be permanent in nature or may be removable or releasable in nature unless otherwise stated.

For purposes of this disclosure, the terms “operably coupled” and “operably connected” generally means that one component functions with respect to another component, even if there are other components located between the first and second component, and the term “operable” defines a functional relationship between components.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible e.g., variations in sizes, dimensions, structures, shapes and proportions of the various elements, values of parameters, mounting arrangements, use of materials, colors, orientations, etc. without materially departing from the novel teachings and advantages of the subject matter recited. For example, elements shown as integrally formed may be constructed of multiple parts or elements shown in multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of the wide variety of materials that provide sufficient strength or durability, in any of the wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is to be understood that variations and modifications can be made on the aforementioned structure and methods without departing from the concepts of the present invention, and further it is to be understood that such concepts are intended to be covered by the following claims unless these claims by their language expressly state otherwise.

What is claimed is:

1. A vehicle seating assembly for a motor vehicle having a lower seat and a seatback extending upwardly from the lower seat, the lower seat comprising:
a cushion frame assembly connected to a vehicle floor, the cushion frame assembly comprising a cushion pan that forms a forward portion of the cushion frame assembly;
a pair of independent thigh supports symmetrically disposed along either side of a longitudinal centerline of the vehicle seating assembly and operably coupled to the cushion pan, wherein each of the independent thigh supports comprises a resilient member having a predetermined hysteresis support-curve to provide independent and resilient support for each thigh of an occupant's legs; and
a cushion foam assembly disposed above and operably coupled to the cushion frame, a forward portion of the cushion foam assembly being supported by the pair of independent thigh supports.

2. The vehicle seating assembly of claim 1, wherein the pair of independent thigh supports comprise a cushion leg jounce bracket having a base operably coupled to a rear portion of the cushion pan and a pair of curved, cantilevered paddles connected with the cushion frame assembly, the pair of paddles extending upwardly and forwardly to form an internal vertical gap between a distal end of each of the pair of paddles and a forward portion of the cushion frame assembly to provide independent and resilient support for an occupant's thighs.

3. The vehicle seating assembly of claim 2, wherein the pair of paddles is symmetrically disposed along either side of a longitudinal centerline of the vehicle seating assembly, and a notch separates each of the paddles along the longitudinal centerline of the vehicle seating assembly.

4. The vehicle seating assembly of claim 1, wherein the pair of independent thigh supports comprises a pair of lattice-shaped support inserts operably coupled to the cushion pan and disposed below the cushion foam assembly.

5. The vehicle seating assembly of claim 4, wherein the pair of lattice-shaped support inserts is symmetrically disposed along either side of a longitudinal centerline of the vehicle seating assembly, and a gap separates each of the lattice-shaped support inserts along the longitudinal centerline of the vehicle seating assembly.

6. The vehicle seating assembly of claim 4, wherein the pair of lattice-shaped support inserts comprises a lightweight polymeric three-dimensionally printed component.

7. The vehicle seating assembly of claim 6, wherein the pair of lattice-shaped support inserts comprises a compressible cuboid disposed between the cushion foam assembly and the cushion pan.

8. The vehicle seating assembly of claim 1, wherein the lower seat further comprises a contact substrate disposed below the cushion foam assembly and the pair of independent thigh supports comprises a pair of spring elements in contact with each of the contact substrate and the cushion pan.

9. The vehicle seating assembly of claim 8, wherein the pair of spring elements is symmetrically disposed along either side of a longitudinal centerline of the vehicle seating assembly, and a gap separates each of the spring elements along the longitudinal centerline of the vehicle seating assembly.

10. The vehicle seating assembly of claim 8, wherein the pair of spring elements each comprises a shaped polymeric or elastomeric member having a base in contact with the contact substrate and a resilient curvilinear cantilevered arm extending forward from the base at an acute angle in contact with the cushion pan.

11. The vehicle seating assembly of claim 10, wherein each of the resilient curvilinear cantilevered arms of the pair of spring elements extend from a lower portion of the base.

12. The vehicle seating assembly of claim 10 wherein the contact substrate and each of the resilient curvilinear cantilevered arms of the pair of spring elements comprise an integrated molded or extruded component.

13. A seat assembly comprising:
a cushion frame assembly comprising a cushion pan;
a trim and foam layer; and
a pair of laterally displaced independent thigh supports disposed between the cushion pan and the trim and foam layer, wherein the pair of independent thigh supports is supported by the cushion pan and resiliently supports the trim and foam layer above the cushion pan.

14. The seat assembly of claim 13, wherein the pair of independent thigh supports extend forwardly to form an internal vertical gap between a distal end of each of the pair of independent thigh supports and a forward portion of the seat assembly.

15. The seat assembly of claim 14, wherein a base of the pair of independent thigh supports is attached to a rear portion of the cushion pan and each of the pair of independent thigh supports extends forward and upward to form the vertical gap between a distal end of each of the pair of independent thigh supports and a forward portion of the cushion pan.

16. The seat assembly of claim 14, wherein each of the pair of independent thigh supports comprise a shaped polymeric or elastomeric member having a base operably coupled with an underside of the trim and foam layer and an arm extending forward from the base at an acute angle operably coupled with the cushion pan.

17. The seat assembly of claim 16, wherein the seat assembly further comprises a contact substrate disposed below and in juxtaposed relation with the trim and foam layer and the base of each of the pair of independent thigh supports is operably coupled with an underside of the contact substrate and each arm extending from the base at an acute angle is in contact with the cushion pan to form a vertical gap between the distal end of each of the pair of arms and a forward portion of the contact substrate.

18. The seat assembly of claim 16, further comprising a contact substrate disposed below the trim and foam layer and each arm extends forward and downward to form a vertical gap between a distal end of each of the arms and a forward portion of the contact substrate.

19. A vehicle seating assembly for a motor vehicle having a lower seat and a seatback extending upwardly from the lower seat, the lower seat comprising:
a cushion frame assembly operably connected to a vehicle floor, wherein a forward portion of the cushion frame assembly comprises a cushion pan;
a pair of independent thigh supports having a predetermined hysteresis support-curve operably coupled with the cushion pan, wherein the pair of independent thigh supports is symmetrically disposed along either side of a longitudinal centerline of the vehicle seating assembly and a gap separates the pair of independent thigh supports along the longitudinal centerline of the vehicle seating assembly; and
a cushion foam assembly disposed above and operably coupled to the cushion frame assembly, wherein a forward portion of the cushion foam assembly is supported by the pair of independent thigh supports.

20. The vehicle seating assembly of claim 19, wherein the pair of independent thigh supports extend forward from a base to form an internal vertical gap between a distal end of each of the pair of independent thigh supports and a forward portion of the lower seat, and the pair of independent thigh supports are disposed between and operably coupled with each of an underside of the cushion foam assembly and the cushion pan.
